(19) United States
(12) Patent Application Publication
(10) Pub. No.: US 2022/0067519 A1
(43) Pub. Date: Mar. 3, 2022

(54) NEURAL NETWORK SYNTHESIS ARCHITECTURE USING ENCODER-DECODER MODELS

(71) Applicant: Affectiva, Inc., Boston, MA (US)

(72) Inventors: Taniya Mishra, New York, NY (US); Sandipan Banerjee, Boston, MA (US); Ajjen Das Joshi, Arlington, MA (US)

(73) Assignee: Affectiva, Inc., Boston, MA (US)

(21) Appl. No.: 17/458,639

(22) Filed: Aug. 27, 2021

Related U.S. Application Data
(60) Provisional application No. 63/083,136, filed on Sep. 25, 2020.
(60) Provisional application No. 63/071,401, filed on Aug. 28, 2020.

(51) Int. Cl. G06N 3/08; G06N 3/04; G06K 9/62; G06K 9/00

(52) U.S. Cl. CPC G06N 3/08; G06N 3/0454; G06K 9/00899; G06K 9/00221; G06K 9/6202

(57) ABSTRACT

Disclosed techniques include neural network architecture using encoder-decoder models. A facial image is obtained for processing on a neural network. The facial image includes unpaired facial image attributes. The facial image is processed through a first encoder-decoder pair and a second encoder-decoder pair. The first encoder-decoder pair decomposes a first image attribute subspace. The second encoder-decoder pair decomposes a second image attribute subspace. The first encoder-decoder pair outputs a transformation mask based on the first image attribute subspace. The second encoder-decoder pair outputs a second image transformation mask based on the second image attribute subspace. The first image transformation mask and the second image transformation mask are concatenated to enable downstream processing. The concatenated transformation masks are processed on a third encoder-decoder pair and a resulting image is output. The resulting image eliminates a paired training data requirement.

### RELATED APPLICATIONS

This application claims the benefit of U.S. provisional patent applications “Neural Network Synthesis Architecture Using Encoder-Decoder Models” Ser. No. 63/071,401, filed Aug. 28, 2020 and “Neural Network Training with Bias Mitigation” Ser. No. 63/083,136, filed Sep. 25, 2020.

Each of the foregoing applications is hereby incorporated by reference in its entirety.

### FIELD OF ART

This application relates generally to machine learning and more particularly to neural network synthesis architecture using encoder-decoder models.

### BACKGROUND

Numerous enterprises use vast quantities of data in their normal operations. The enterprises include small, medium-sized, and large ones, and range from manufacturing to financial institutions, health care facilities, academic and research institutions, online retailers, and government agencies, among many others. The data can be well organized, but in many cases, the data is unstructured. In attempts to manage, analyze, and monetize the data, the enterprises have capitalized on artificial intelligence (AI) techniques such as machine learning. The machine learning techniques can be used to discover trends within the data and to make inferences about the data. Financial businesses and banks are using machine learning techniques to detect anomalies in account usage patterns. Such detection can be used to prevent fraud, repeated charges, and transactions from disreputable vendors. On the plus side, machine learning can be used by these same institutions to identify investment opportunities. Government agencies use machine learning techniques to identify and reduce the risk of identity theft, to increase bureaucratic efficiency, and to reduce cost.

Machine learning techniques offer advantages beyond detection of criminal or deceptive behavior. Medical experts use machine learning technology to identify trends or “red flags” in patient data such as X-ray, CT, and MRI scan results. Data analysis based on machine learning yields improved diagnoses of medical conditions and can suggest improved and appropriate treatment. Retailers, whether “bricks and mortar” or online, use AI to personalize customers' shopping experiences, run marketing campaigns, and optimize pricing. The personalization is based on items viewed during the current and previous site visits, purchasing history, and personal preferences. The oil and gas industries apply AI technology to ground penetration data and geological structure information to predict drilling locations that are most likely to be productive and thus lucrative. AI is further used to streamline distribution plans, and to predict equipment failures such as sensor failures. Real-time insights that are yielded by AI and machine learning techniques help organizations identify profitable opportunities and avoid risks.

Machine learning has gained popularity due to its ability to handle growing volumes and varieties of data, while providing powerful and efficient computational processing. Machine learning can therefore reduce processing costs. Machine learning can implement models, which in turn can automatically generate additional models to analyze complex data. However, the widespread use of machine learning faces societal and technological challenges. Some customers distrust and even fear AI technology, citing privacy and bias concerns. Further, the preparation of data for training is complex and expensive. Training of machine learning systems requires large quantities of precisely organized data in order to provide accurate results. A fully trained system with 100% accuracy based on training set data and results can still completely fail when given new data.

### SUMMARY

Machine learning automates analytical model building, which enables a system to analyze large volumes of complex data and to deliver faster results. One field of study that has benefitted from machine learning is facial analysis. Automatic facial analysis has many applications ranging from face verification to expression classification. Facial expressions provide real-time, objective data indicating emotional states, mindsets, and intentions. This information can be used to improve user experiences, develop marketing campaigns, increase health and safety, and enhance human-computer interactions.

Building robust and accurate models requires large quantities of facial image training datasets. Currently, the training datasets available are limited and often fail to reflect the “true” distribution of real-world data. This skews the representations and causes poor performance on sparse image classes. Few datasets reflect extreme variations in lighting conditions and facial expressions. To alleviate these problems, natural-looking synthetic facial images can be generated and used for training. However, current synthetic face generators do not include an accurate, automated metric to judge the quality of the synthetic image. They do not consider human judgments of naturalness. Most rating systems which are used to score the naturalness of synthetic images have not been designed for face images, and one designed for facial images was trained on less than 5000 images, making it insufficient to reliably model the subjective nature of human judgments. Also, current synthetic face generators cannot manipulate the direction of the lighting source to reflect “in-the-wild” real-world scenarios.

In disclosed techniques, machine learning is accomplished using one or more neural networks. The neural networks can include generator neural networks and discriminator neural networks. The generator networks and the discriminators are often components of generative adversarial networks (GANs). The generator neural networks can be based on encoder-decoder pairs. The encoder-decoder pairs, or hourglass networks, are used to synthesize facial images. The synthesized facial images differ from a “basis” or original image in terms of facial lighting, lighting direction, and facial expression. The synthesized facial images that include altered lighting and facial expression are processed by the discriminator neural networks. The discriminator neural networks process the synthetic images to determine “realness” or authenticity of the synthetic images. That is, the discriminator networks attempt to determine whether the synthetic images created by the generator networks “look real”, are obviously not real, or are close enough for training purposes. The reasons to create these synthetic images include training a neural network using machine learning techniques. Since the quality of training a machine language system improves by using larger amounts of training data, and since training libraries of real images tend to be small, large numbers of synthetic images can be created to further improve the machine learning objectives.

In the GAN networks discussed here, the generator tries to create data, called synthetic data, which is able to fool the discriminator into thinking that the data is real. The data that is created or synthesized comprises synthetic facial images in which facial lighting and facial expressions have been altered. The discriminator tries to detect all synthetic data and label the synthetic data as fake. These adversarial roles of the generator and discriminator enable improved generation of synthetic data. The synthetic data is used to enhance training of the machine learning neural network. The neural network training can be based on adjusting weights and biases associated with layers, such as hidden layers, within the neural network. The results of the neural network training based on the augmenting with the synthetic data can be used to further train the neural network, or can be used to train an additional neural network such as a production neural network. The training can be based on determinations that include true/false, real/fake, and so on. The trained neural network can be applied to a variety of analysis tasks including analysis of facial elements, facial expressions, cognitive states, mental states, emotional states, moods, and so on.

The known good data is processed by the machine learning system in order to adjust weights associated with various layers within the neural network. The adjustments of weights can include weights associated with the GAN, a deep learning neural network, and so on. Additional adjustments to the training of the neural network can be accomplished by applying further known good data and adjusting additional weights. In embodiments, the training data, which can include synthetic facial images, is augmented with generated synthetic images. As the neural network is being trained, additional synthetic data such as synthetic facial images can be generated. The synthetic data can be created, filtered, supplemented, modified, and so on. The synthetic data that can be generated to augment the training dataset can be received from a generative adversarial network, or GAN. The results of training the neural network with the training dataset and the augmented (synthetic facial image) training dataset can be used to train further neural networks.

A computer-implemented method for machine learning is disclosed comprising: obtaining a facial image for processing on a neural network, wherein the facial image includes unpaired facial image attributes; processing the facial image through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace; and concatenating the first image transformation mask and the second image transformation mask to enable downstream processing. The first image transformation mask and the second image transformation mask that are concatenated are on a third encoder-decoder pair, and a resulting image is output. The resulting image is discriminated against a known-real image, where the discrimination is accomplished using strided convolutional layers and activation layers. The discriminating provides a realness matrix and a classification map, where the classification map predicts the lighting and expression states of the resulting image. The prediction is compared with a target set by a user.

The machine learning system that is trained can be used to enable vehicle manipulation. The vehicle manipulation can include selecting a media presentation for a person within the vehicle, and can further include adjusting seating, lighting, or temperature. The vehicle manipulation can also include operating the vehicle in autonomous or semi-autonomous mode, and so on. When audio information or physiological information is obtained, the audio information or the physiological information can augment the training of the neural network. The audio information can include speech, non-speech vocalizations, and so on. The non-speech vocalizations can include grunts, yelps, squeals, snoring, sighs, laughter, filled pauses, unfilled pauses, or yawns. Further embodiments include obtaining physiological information and augmenting the training dataset based on the physiological information. The physiological information can include heart rate, heart rate variability, respiration rate, skin conductivity, and so on.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a neural network synthesis architecture using encoder-decoder models.

FIG. 2 is a flow diagram for image discrimination.

FIG. 3A is a block diagram for generator usage.

FIG. 3B shows an encoder-decoder pair.

FIG. 4 illustrates training using an hourglass network.

FIG. 5 is a table showing an hourglass architecture for expression mask synthesis.

FIG. 6 is a table illustrating an hourglass architecture for lighting mask synthesis.

FIG. 7 is a table showing an hourglass architecture for target image synthesis.

FIG. 8 is a table illustrating an architecture for a quality estimation model.

FIG. 9 is a table showing an architecture of a discriminator.

FIG. 10 is a system diagram for an interior of a vehicle.

FIG. 11 is an example showing a convolutional neural network (CNN).

FIG. 12 illustrates a bottleneck layer within a deep learning environment.

FIG. 13 shows data collection including devices and locations.

FIG. 14 is a system for a neural network synthesis architecture using encoder-decoder models.

### DETAILED DESCRIPTION

In the disclosed materials, machine learning is based on encoder-decoder models which are used to form generators for synthesizing facial images. The encoder-decoder pairs, or hourglass networks, are used to process facial images in order to downsample into lower dimensional attribute space and then to upsample to the desired attributes. An unpaired facial image comprises a facial image that is not associated with a second facial image which includes changes in facial lighting, lighting direction, facial expression, and so on, for the same subject identity, when compared to the unpaired image. The changes between the first (or input) image and a second (or target) image can include changing lighting from dim to bright, changing the direction of a lighting source, changing a facial expression from neutral to smiling, and so on. The attribute subspaces that can be decomposed can include a facial lighting subspace, a facial expression subspace, and the like. The results of the decompositions can include one or more transformation masks. The transformation masks can be concatenated and can be used to transform the input image from dim to light, light to dark, and so on. The transformation masks can be further used to transform the lighting direction and facial expressions within the unpaired input image.

A resulting image is generated or synthesized by leveraging the transformation masks extracted from the unpaired input image. The resulting image is processed using a discriminator, where the discriminator attempts to determine whether the resulting image is real, is a fake, or is “real enough” to be used for training a machine learning network. The generation and discrimination can be used to generate training data that is sufficiently real in order to enhance the robustness of the machine learning. Training of a machine learning network is improved by providing large amounts of data during training, yet training datasets are relatively small and are difficult to produce since the production of a training dataset typically requires significant human intervention. The generating of synthetic images and the discriminating of the synthetic images can comprise a generative adversarial network (GAN) technique. The GAN uses generator and discriminator neural networks which compete with each other using a min-max game. Facial images are processed using the concatenated transformation masks to synthesize facial images suitable for training a machine learning network. The generator neural network or hourglass network within the GAN is trained to provide synthetic facial images, where the synthetic facial images include altered lighting, altered lighting direction, and altered facial expression relative to an original, or “starter,” image. The training of the generator neural network to generate synthetic facial images can be designed to avoid detection by the discriminator neural network. That is, a “good” synthetic facial image is indistinguishable by the discriminator from a real facial image. With the generator trained, additional synthetic facial images can be generated by the GAN. The additional synthetic vectors can supplement the training of downstream machine learning neural networks.

Neural network training is based on techniques such as applying “known good” data to the neural network in order to adjust one or more weights or biases, to add or remove layers, etc., within the neural network. The adjusting weights can be performed to enable applications such as machine vision, machine hearing, and so on. The adjusting weights can be performed to determine facial elements, facial expressions, human perception states, cognitive states, emotional states, moods, etc. In a usage example, the facial elements comprise human drowsiness features. Facial elements can be associated with facial expressions, where the facial expressions can be associated with one or more cognitive states. The various states can be associated with an individual as she or he interacts with an electronic device or a computing device, consumes media, travels in or on a vehicle, and so on. However, a lack of diversified training datasets causes poor performance, especially in under-represented classes. Further, learning models might not reflect “in-the-wild” real-life conditions. That is, the quality of machine learning results is limited by the training datasets available, hence the need for high quality synthetic training data. The synthetic data for neural network training can use synthetic images for machine learning. The machine learning is based on obtaining facial images for a neural network training dataset. A training dataset can include facial lighting data, facial expression data, facial attribute data, image data, audio data, physiological data, and so on. The images can include video images, still images, intermittently obtained images, and so on. The images can include visible light images, near-infrared light images, etc. An encoder-decoder pair can decompose an image attribute subspace and can produce an image transformation mask. Multiple image transformation masks can be generated, where the transformation masks can be associated with facial lighting, lighting source direction, facial expression, etc.

Extreme variations in lighting and expressions that occur during “in-the-wild” conditions are difficult to replicate while maintaining a realistic, natural-looking image under constrained settings. For example, current synthetic image generators that start with a real-life facial image of an Asian woman who is smiling in bright light will struggle to hallucinate a realistic, natural-looking image of that Asian woman who shows disgust and has a shadow on the left side of her face. Hallucinating an image is synthesizing or manipulating pixels where there is no ground-truth image, e.g., in this case, no real-life image of the Asian woman scowling in the dark, with which to compare the synthesized image. The inability to synthesize diverse, natural-looking facial images hampers training dataset augmentation. Without large numbers of diverse, “in-the-wild” facial images in training datasets, the system's machine learning will have inherent biases and will perform poorly on sparse classes of images.

The present disclosure provides a description of various methods and systems for natural-looking synthetic facial image generation. A generator comprised of three hourglass networks, which are encoder-decoder pairs, starts with an input facial image and a target attributes vector. The input facial image is an RGB image that includes unpaired attributes. The target attributes vector includes expressions and lighting conditions. The first encoder-decoder pair receives the input image concatenated with the lighting condition attribute, and the second encoder-decoder pair receives the input image concatenated with the expression attribute. This disentangles the transformation task, which enables separate neural network processing of the lighting condition subspace and the expression subspace, and eases the task of each encoder-decoder pair. In the lighting condition subspace, the concatenated facial image is processed using strided convolutional layers, residual block layers, pixel shuffling layers, and activation layers. Likewise, in the emotion subspace, the concatenated image is processed through strided convolutional layers, residual block layers, pixel shuffling layers, and activation layers. The resulting upsampled facial images include a lighting condition transformation mask and an emotion transformation mask. These two transformation masks are then concatenated and input to a third encoder-decoder pair, where they are processed using strided convolutional layers, residual block layers, pixel shuffling layers, and activation layers. Then the generator hallucinates an output synthetic facial image. During training of this generator, a discriminator predicts the output image's realness score and classifies its attributes. It calculates loss functions to refine the facial image. The auxiliary discriminator further refines the naturalness of the synthetic facial images by calculating a loss function based on an automated proxy for human judgment. The discriminator is trained with the generator, but the auxiliary discriminator is not. During testing, only the generator is required to hallucinate natural-looking synthetic facial images. These images can augment training datasets to increase the diversity of the facial images used to train machine learning systems and improve results.

A facial image is obtained for processing on a neural network. The facial image can include facial data, facial lighting data, lighting direction data, facial expression data, and so on. The facial image can include an unpaired facial image. The facial image can be used for training a machine learning neural network. Training data can include facial image data, facial expression data, facial attribute data, voice data, physiological data, and so on. Various components such as imaging components, microphones, sensors, and so on can be used for collecting the facial image data and other data. The imaging components can include cameras, where the cameras can include a video camera, a still camera, a camera array, a plenoptic camera, a web-enabled camera, a visible light camera, a near-infrared (NIR) camera, a heat camera, and so on. The images and/or other data are processed on a neural network. The images and/or other data can be further used for training neural network. The neural network can be trained for various types of analysis including image analysis, audio analysis, physiological analysis, and the like. The facial image is processed through a first encoder-decoder pair and a second encoder-decoder pair. The encoder-decoders pairs, or hourglass networks, comprise a generator network. The first encoder-decoder pair decomposes a first image attribute subspace and the second encoder-decoder pair decomposes a second image attribute subspace. An attribute subspace can include a facial lighting subspace and a facial expression subspace. The first encoder-decoder pair outputs a first image transformation mask based on the first image attribute subspace and the second encoder-decoder pair outputs a second image transformation mask based on the second image attribute subspace. The transformation masks can be used to transform the obtained image with respect to lighting and facial expression. The first image transformation mask and the second image transformation mask are concatenated to enable downstream processing. The processing includes processing the first image transformation mask and the second image transformation mask that are concatenated on a third encoder-decoder pair. The resulting image is output from the third encoder-decoder pair.

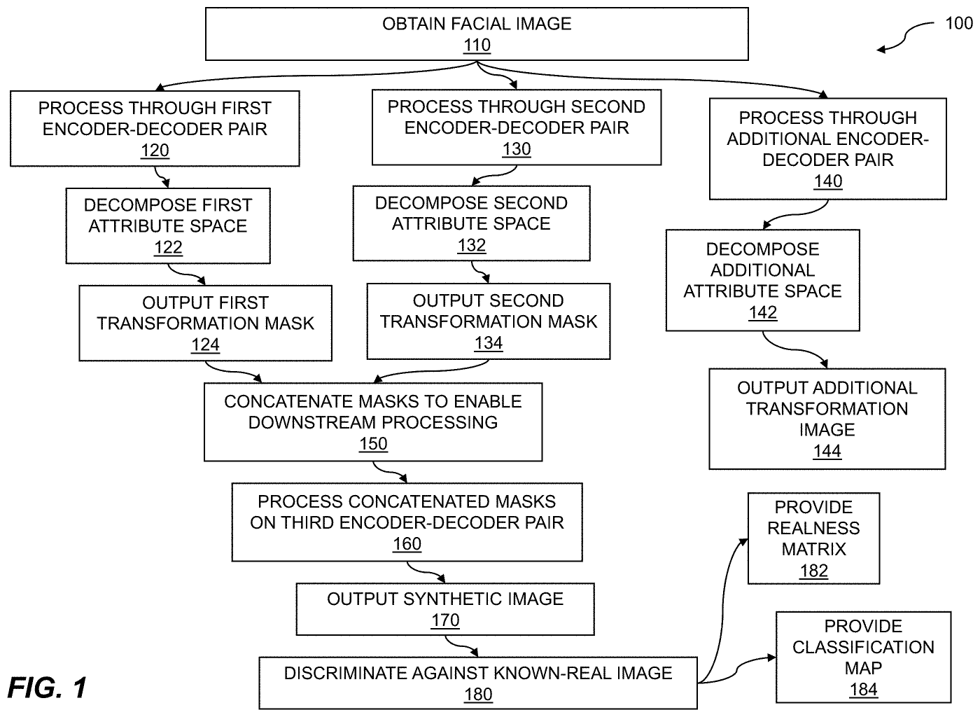

FIG. 1 is a flow diagram for a neural network synthesis architecture using encoder-decoder models. The flow diagram 100 is based on a computer-implemented method for machine learning. The flow 100 includes obtaining a facial image 110 for processing on a neural network, wherein the facial image includes unpaired facial image attributes. In embodiments, the image data comprises RGB image data. The neural network to be trained can be based on various neural network techniques, configurations, etc. The neural network can be implemented on a machine learning system. The facial image can include a facial image from a plurality of facial images that comprise a training dataset. The facial images training dataset can be uploaded by a user, downloaded from a library or repository over a network, and so on. The facial image can include one or more facial expressions. The facial image can include lighting attributes such as bright, dark, dim, etc. The facial expressions can include a smile, frown, or smirk; an eyebrow furrow; and so on. The facial expressions can comprise human drowsiness features. The facial expressions and lighting can convey one or more cognitive states. The facial expressions and lighting can indicate happy, disgusted, angry, fearful, surprised, sad, and so on. The neural network that can be trained using the facial images training dataset can include a deep learning (DL) neural network, a convolutional neural network (CNN), a recurrent neural network (RNN), and the like. In embodiments, the neural network that is trained can comprise a convolutional neural network or a recurrent neural network within a machine learning system. The machine learning system can be based on an integrated circuit or chip; on a computer such as a laptop or desktop computer; or on a personal electronic device such as a smartphone, tablet, or personal digital assistant (PDA), etc. The semiconductor chip can include a standalone chip, a subsystem of a chip, a module of a multi-chip module (MCM), and so on. The semiconductor chip can include a programmable chip such as a programmable logic array (PLA), a programmable logic device (PLD), a field programmable gate array (FPGA), a read only memory (ROM), and so on. The semiconductor chip can include a full-custom chip design. The semiconductor chip can be reprogrammed, reconfigured, etc., “on the fly”, in the field, or at any time convenient to the user of the semiconductor chip. The semiconductor chip can be implemented in any semiconductor technology. The machine learning system can include a convolutional neural network (CNN). In other embodiments, a machine learning system can include a multi-layer perceptron. A perceptron can include an algorithm, based on supervised learning, that can be used for learning classifiers.

An unpaired image comprises an image that includes lighting attributes, facial expression attributes, and so on. In embodiments, the unpaired image data can include lighting conditions and facial expressions. The image is “unpaired” in the sense that there is no additional image included within a dataset, such as a training dataset, that includes changes to the image attributes for the same subject identity that might be desired by a user. In a usage example, consider a first image in which the image attributes include dim lighting, a lighting source located image right, and a facial expression including a frown. If a user were to desire a second image different from the first image with respect to lighting, light source direction, and facial expression, no such second image would be present within the training dataset.

The flow 100 includes processing 120 the facial image through a first encoder-decoder pair. The encoder-decoder can be based on layers within the neural network. An encoder-decoder pair comprises an hourglass network. Various types of neural network layers can be included within the hourglass network. In embodiments, the hourglass network can include convolutional layers, residual blocks, pixel shuffling layers, and activation layers. The activation layers can be based on rectifier linear units (ReLUs), leaky ReLUs, and so on. The hourglass network can downsample an image using a strided convolutional layer. The downsampling can accomplish data compression and removal of redundant features. In the flow 100, the first encoder-decoder pair decomposes 122 a first image attribute subspace. An attribute subspace can be associated with an image attribute, such as image lighting, lighting source direction, facial expression, and so on. In embodiments, the first image attribute subspace can include facial image lighting. In the flow 100, the first encoder-decoder pair outputs 124 a first image transformation mask based on the first image attribute subspace. The image transformation mask can be used to transform an image attribute such as changing the lighting within an image. In embodiments, the first image transformation mask includes changing facial image lighting. In other embodiments, the first image transformation mask highlights salient pixels for the first image attribute subspace.

The flow 100 includes processing 130 the facial image through a second encoder-decoder pair. The processing through the second encoder-decoder pair can be used to analyze a second image attribute subspace. In the flow 100, the second encoder-decoder pair decomposes 132 a second image attribute subspace. The second image attribute subspace can include an attribute subspace different from the first attribute subspace. In embodiments, the second image attribute subspace can include facial image expression. The facial image expression can include a smile, a frown, a smirk, a neutral expression, etc. In the flow 100, the second encoder-decoder pair outputs 134 a second image transformation mask based on the second image attribute subspace. The second image transformation mask can be used for changing the second image attribute. In embodiments, the second image transformation mask includes changing a facial image expression. In other embodiments, the second image transformation mask highlights salient pixels for the second image attribute subspace.

The flow 100 includes processing 140 the facial image through an additional encoder-decoder pair. The processing through the additional encoder-decoder pair can be used to analyze one or more additional image attribute subspaces. In the flow 100, the additional encoder-decoder pair enables decomposition 142 of an additional image attribute subspace. The additional image attribute subspace can include facial attributes other than facial lighting and facial expression. In embodiments, the additional facial attributes can include hair color or style; eye color or shape; facial coverings such as glasses, an eyepatch, or a veil; facial features such as a scar; and the like. In the flow 100, the additional encoder-decoder pair outputs 144 an additional image transformation mask based on the additional image attribute subspace. The additional image transformation mask can be used for making changes to the additional image attribute. In embodiments, the additional image transformation mask highlights salient pixels for the additional image attribute subspace.

The flow 100 includes concatenating 150 the first image transformation mask and the second image transformation mask to enable downstream processing. The concatenation of the first and second transformation masks can be based on various techniques including addition techniques. The addition techniques can include arithmetic addition, vector addition, matrix addition, and so on. The flow 100 further includes processing 160 the first image transformation mask and the second image transformation mask that are concatenated on a third encoder-decoder pair. The third encoder-decoder pair or hourglass network can include layers within the neural network. The downstream processing can include arithmetic, scalar, vector, matrix, and other operations. The downstream processing can be accomplished within layers of the neural network. The flow 100 includes outputting 170 a resulting synthetic image from the third encoder-decoder pair. The resulting image can include one or more transformations made to the facial image. The transformations can include changes in facial image lighting, changes in light source direction, changes in facial expression, and so on. More than one transformation can be present within the resulting image. In embodiments, the resulting image that is output can eliminate a paired training data requirement for the neural network to learn two or more facial image transformations.

The flow 100 includes discriminating 180 the resulting image against a known-real image. Various techniques can be used for the discriminating. In embodiments, the discriminating can be accomplished using strided convolutional layers and activation layers. Discussed below, the using strided convolutional layers and activation layers can accomplish data compression and can speed computational operations. In the flow 100, the discriminating provides a realness matrix 182. The realness matrix can provide an estimation or evaluation related to how real a resulting or synthetic image appears. The realness matrix can be used to determine whether a synthetic image is suitable for use in training the neural network. In the flow 100, the discriminating provides a classification map 184. The classification map can be generated using classifiers, where the classifiers can include lighting classifiers, facial expression classifiers, etc. In embodiments, the classification map predicts lighting and expression states of the resulting image.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

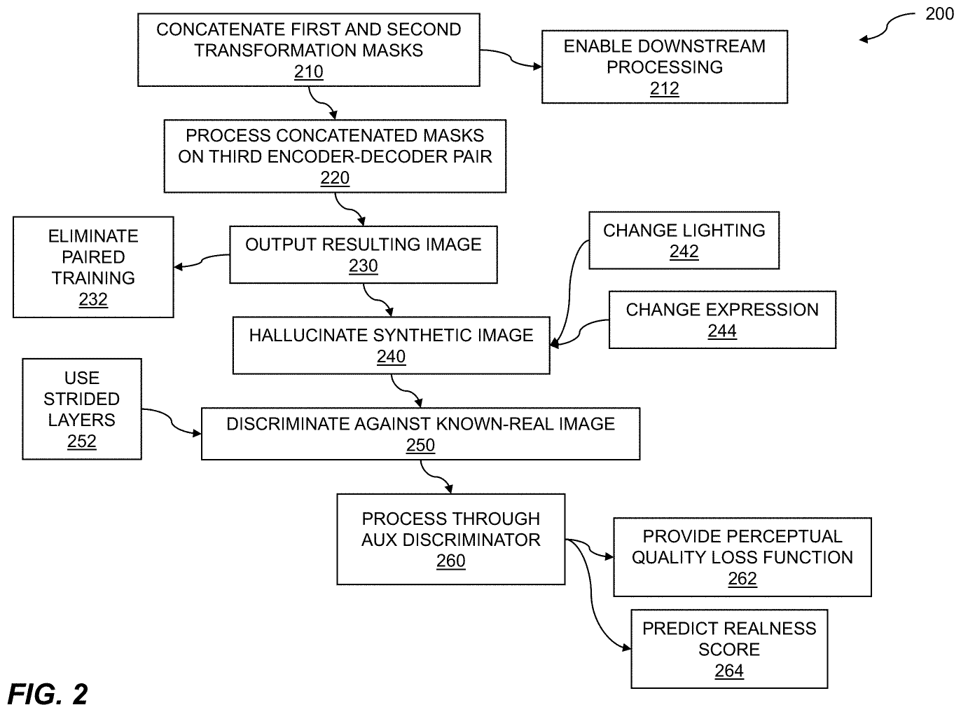

FIG. 2 is a flow diagram for image discrimination. For machine learning techniques, a network such as a neural network can be trained. The neural network is trained by providing training data for processing by the neural network, where the data comprises data and known results. Since the training data is often generated “by hand”, training datasets are by necessity small. Synthetic test data can be generated, where the synthetic test data mimics the “real” test data. In order to ensure the quality of the synthetic data, the synthetic data is discriminated for “realness” and classification. That is, the discrimination ensures that the synthetic data sufficiently resembles real data, thus ensuring the efficacy of the synthetic data for training purposes. The discrimination of synthetic data such as facial images enables a neural network synthesis architecture using encoder-decoder models.

The flow 200, or portions thereof, can be implemented using one or more computers, processors, personal electronic devices, and so on. The flow 200 can be implemented using one or more neural networks. The flow 200 describes further training a neural network synthesis architecture by generating synthetic images including facial images and evaluating a realness and an accuracy of the generated synthetic images. The generation of the synthetic images can be improved by back-propagating a reconstruction error function. The training the neural network synthesis architecture can be based on image attributes such as facial lighting, lighting source direction, and facial expression of one or more people. The image is decomposed into image attribute subspaces, and transformation masks are output based on the image attribute subspaces. In embodiments, the one or more people can be occupying one or more vehicles. The image attributes can comprise human drowsiness features. The back-propagating is based on synthetic data for neural network training using synthetic images. The flow 200 includes concatenating 210 a first image transformation mask and a second image transformation mask. The concatenation can be based on arithmetic addition, vector addition, matrix addition, and so on. The transformation masks can be associated with image attribute subspaces, where the image attribute subspaces can include facial image lighting, facial expression, and so on. In the flow 200, the concatenation enables downstream processing 212. The downstream processing can include processing for synthetic image generation.

The flow 200 includes processing 220 the first image transformation mask and the second image transformation mask that are concatenated on a third encoder-decoder pair. The third encoder-decoder pair can be realized within a neural network such as a neural network for machine learning. The encoder-decoder pair or hourglass network comprises layers within the neural network. In embodiments, the hourglass network can include convolutional layers, residual blocks, pixel shuffling layers, and activation layers. The flow 200 includes outputting a resulting image 230 from the third encoder-decoder pair. The image that is output can include a synthetic image based on an unpaired image. The synthetic image can vary from the unpaired image with respect to facial lighting, lighting source direction (e.g., from left, from right, from overhead, etc.), facial expression, and so on. In the flow 200, the resulting image that is output can eliminate a paired training 232 data requirement for the neural network to learn two or more facial image transformations. Paired training is based on providing an image and a paired image, where the paired image differs from the image with respect to lighting, facial expression, etc. Paired training can be eliminated by synthesizing the paired image from the original image.

In the flow 200, the resulting image is hallucinated 240 to a new synthetic image. Just as in the general meaning of “hallucinate”, here the term is used to present changes to image attribute subspaces that were not present in the original, unpaired image. In embodiments, the image that can be hallucinated includes a synthetic image. In the flow 200, the hallucinating the new synthetic image can be based on changing 242 facial image lighting. The changing facial image lighting can include changing lighting intensity such as bright, outdoor, indoor, dim, and so on. In other embodiments, the changing facial image lighting can include changing a direction of the lighting on the facial image. In the flow 200, the hallucinating the new synthetic image can be based on changing 244 facial expression. The changing facial expression can include changing from the facial expression within the unpaired image to a smile, frown, smirk, neural expression, sad or angry expression, happy or elated expression, etc.

The flow 200 includes discriminating 250 the resulting image against a known-real image. The discriminating can include comparing the resulting image against similar known-real images. In a usage example, a resulting image that is brightly lit and includes a broad smile can be compared to images known to be brightly lit and to include broad smiles. The discriminating can be computationally intensive. In the flow 200, the discriminating can be accomplished using strided 252 convolutional layers and activation layers. The use of strided convolutional layers and activation layers can accomplish data compression and can reduce computational requirements to accomplish the discriminating. In embodiments, the discriminating can provide a realness matrix. The realness matrix can be based on a range of values, a percentage, a threshold, and so on. The realness matrix can be used to convey how “real” the resulting image looks in comparison to known-real images. In other embodiments, the discriminating can provide a classification map. A classification map can be generated based on the use of classifiers. The classifiers can be used to determine a level of facial lighting and lighting direction, a facial image, etc. In embodiments, the classification map can predict the lighting and expression states of the resulting image. The lighting states can include bright, natural, dim, dark, etc. The expression states can include a facial expression such as smile, frown, smirk, etc., and an intensity of the facial expression. Embodiments further can include comparing the prediction with a target set by a user. The user can set targets for a resulting image, such as dim lighting and frown, bright lighting, and smile, etc.

The flow 200 includes processing the resulting image 260 through an auxiliary discriminator. The auxiliary discriminator can include a discriminator which is distinct from or separate from the discriminator. The auxiliary discriminator can be used to discriminate among the original or input image, the resulting image, a reconstructed version of the input image, and so on. The auxiliary discriminator can calculate values associated with differences among the input, resulting, and reconstructed images. In the flow 200, the auxiliary discriminator provides a perceptual quality loss function 262 for the resulting image. The perceptual quality loss can be based on a value, a threshold, a range of values, a percentage, etc. In the flow 200, the auxiliary discriminator can predict a realness score 264 for the resulting image. The realness score can include a value, a range of values such as “7.5 out of 10”, a threshold, a percentage, etc.

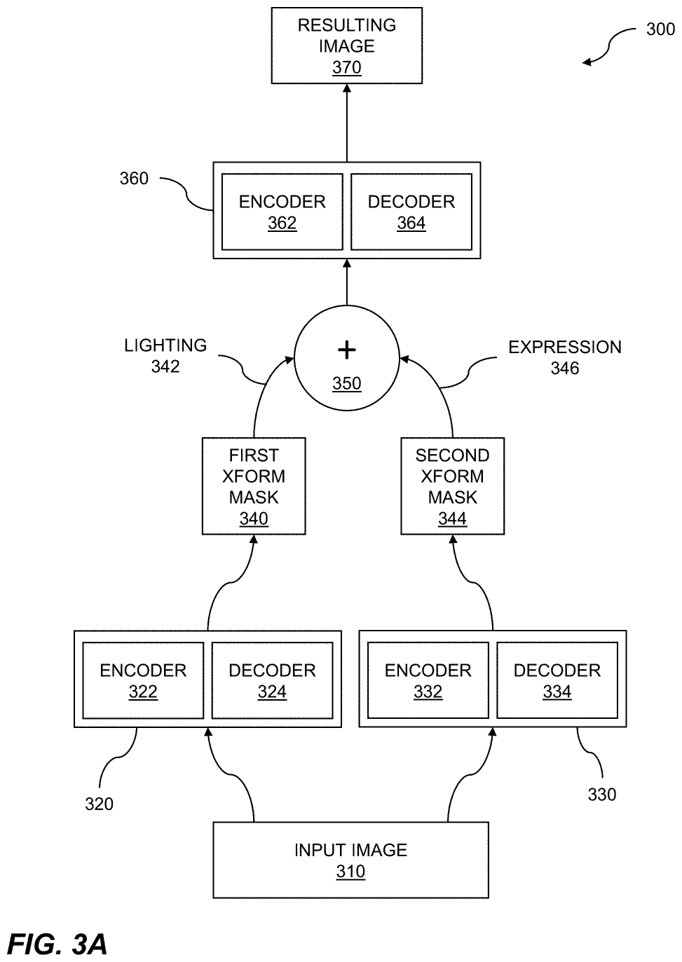

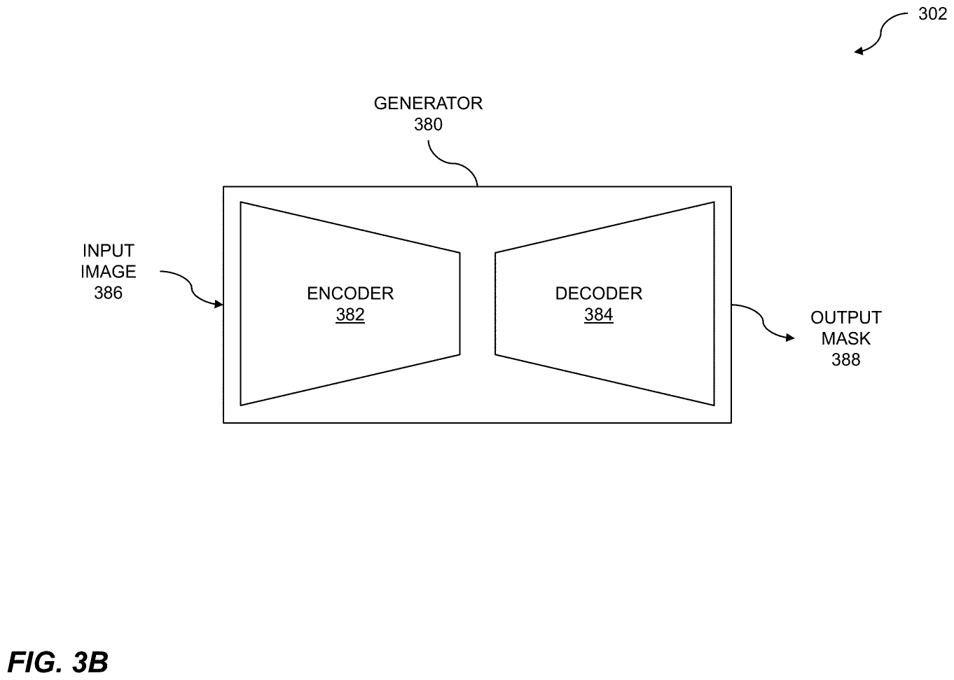

FIG. 3A is a block diagram for generator usage. A generator or encoder-decoder pair can be used to generate a transformation mask from an image. The transformation mask can be associated with an image attribute subspace. An image attribute subspace can include image lighting, lighting source direction, facial expression, and so on. The transformation mask can be used to transform an image such as an unpaired image to a synthesized image in which image lighting or source direction, facial expression, etc. have been changed. Generator usage enables neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing.

In the block diagram 300, an input image 310 is processed through a first generator 320. The generator includes an encoder 322 and a decoder 324 which form an encoder-decoder pair or hourglass network. The input image 310 is further processing through a second generator 330. The second generator comprises an encoder 332 and a decoder 334 which form the second encoder-decoder pair. The first generator 320 decomposes a first image attribute subspace and outputs a first transformation mask 340. The transformation mask can be used to change image attributes. In embodiments, the first image transformation mask includes changing facial image lighting 342. The second generator 330 decomposes a second attribute subspace and outputs a second transformation mask 344. In embodiments, the second image attribute subspace comprises a facial image expression. The second transformation mask can be used to change further image attributes. In embodiments, the second image transformation mask includes changing a facial image expression 346. The first transformation mask and the second transformation mask are concatenated 350. The concatenation can be based on matrix addition, vector addition, and so on. In embodiments, the first image transformation mask and the second image transformation mask that are concatenated can be processed on a third encoder-decoder pair 360. The third encoder-decoder pair comprises an encoder 362 and a decoder 364. The third encoder-decoder pair can be used to perform various operations. In embodiments, the third encoder-decoder pair combines feature maps from previously decomposed attribute subspaces. Further embodiments include outputting a resulting image 370 from the third encoder-decoder pair. The resulting or synthesized image can be compared to real images to determine a “realness” factor or quality of the synthesized image. The realness or quality of the resulting image can be determined by discrimination. In embodiments, the discriminating provides a realness matrix and a classification map. The classification map can predict the lighting and expression states of the resulting image.

FIG. 3B shows an encoder-decoder pair. Described throughout, an encoder-decoder pair or “hourglass” network can be used for processing a facial image. The encoder-decoder pair can decompose an image attribute subspace from the image, where the image attribute subspace can include facial image lighting, light source direction, facial expression, and so on. An encoder-decoder pair 302 can use processing models, where the encoder-decoder models enable a neural network synthesis architecture. A generator 380 comprises an encoder 382 and a decoder 384. The encoder and the decoder can include layers within a neural network. The encoder-decoder pair or hourglass network can include convolutional layers, residual blocks, pixel shuffling layers, and activation layers. The hourglass network can be used to process an input image 386 and can generate an output mask 388. In embodiments, each hourglass network downsamples an image using a strided convolutional layer. Although the downsampling can cause data loss through compression, the reduced data size can expedite the processing of images such as facial images.

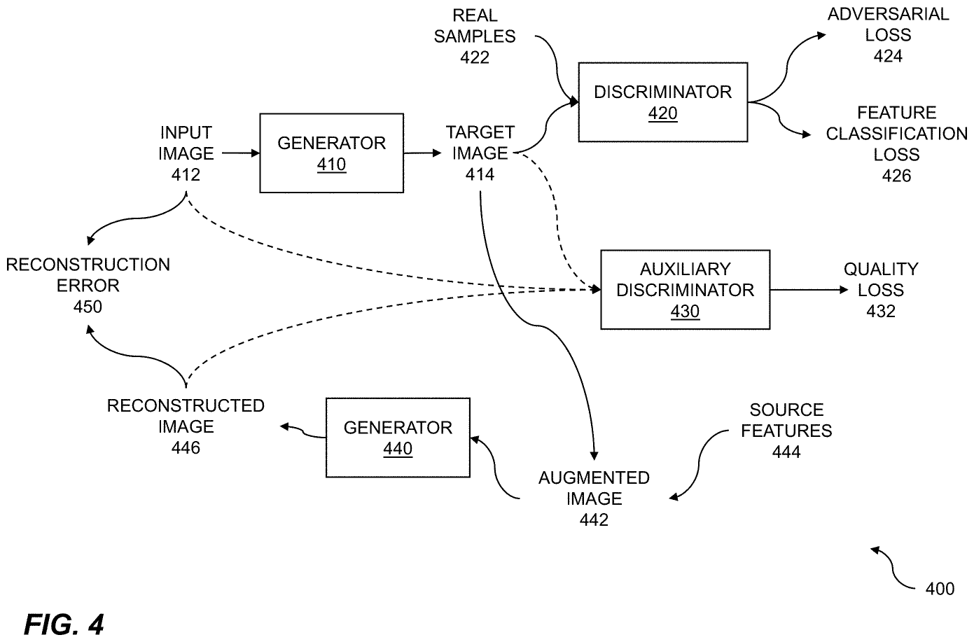

FIG. 4 illustrates training using an hourglass network. In order for a neural network such as a neural network that is based on one or more hourglass networks to operate properly, the neural network must be trained. The training of the neural network includes providing training data to the neural network, where the training data comprises input data such as facial image data and known results. The training data can be generated by experts who evaluate the images visually and generate the expected results. However, manually generated training datasets are difficult and expensive to produce and as a result tend to have few training data-result pairs. To increase the sizes of training dataset, synthetic images and expected results can be generated. Training for a network that comprises generators and discriminators is shown 400. Generators use hourglass networks to synthesize images, while discriminators try to analyze the synthetic images to determine a degree of realness. Training using hourglass networks enables a neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace. As such, the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing. The concatenated transformation masks are processed on a third encoder-decoder pair, and a resulting synthetic image is output.

A generator 410 includes an encoder-decoder pair, where the encoder-decoder pair comprises an hourglass network. The generator obtains an input image 412, a target expression, and target lighting. In embodiments, the image data comprises RGB image data. The generator processes the input image to synthesize a target image 414. In embodiments, the input image is decomposed into attribute subspaces for expression and lighting using a pair of hourglass networks, one hourglass network for each attribute subspace. In embodiments, the processing of the facial image enables disentanglement of the first image attribute subspace and the second image attribute subspace for the facial image. The disentanglement can be used to parallelize processing of the input image. In embodiments, the disentanglement enables separate neural network processing of the facial image for the first image attribute subspace and the second image attribute subspace. The results of the decomposition include transformation masks for lighting and expression. The concatenated transformation masks are processed on a third hourglass network. The resulting image is then “hallucinated” as the target image 414. The target image includes a target facial lighting and lighting direction, a target facial expression, and so on. In a usage example, the input image can include dim facial lighting and a frown, while the target image includes bright facial lighting and a smile. In embodiments, the resulting image that is output eliminates a paired training data requirement for the neural network to learn two or more facial image transformations. The target image is provided to a discriminator 420. Further embodiments include discriminating the resulting image against a known-real image. The discriminator compares the target image to real samples 422, where the real samples 422 include images in which the target lighting, lighting direction, and facial expression are present. The discriminator can act in an adversarial role with respect to the generator (e.g., a generative adversarial network or GAN configuration). In embodiments, the discriminating is accomplished using strided convolutional layers and activation layers. The discriminator 420 can generate losses, errors, and so on as a result of comparing the representations of the target image with real samples that represent the different aspects (e.g., lighting, expressions, etc.) of the target image. In embodiments, the discriminator can generate an adversarial loss 424. The adversarial loss can include target images that are rejected by the discriminator, because the discriminator determined that the target (synthesized image) was indeed synthesized, rather than a real image. The discriminator can generate a feature classification loss 426. The feature classification loss penalizes synthesized images that have incorrect or insufficient lighting, a facial expression that does not adequately match the target facial image, etc.

An augmented image 442 can be generated from the target image 414 by augmenting the target image with source features 444. The source features can include a facial expression and facial lighting which can be used to enhance the target image. The augmented image is provided to a generator 440, where this latter generator attempts to reconstruct the input image to produce a reconstructed image 446. The input image 412 and the reconstructed image 446 can be compared to determine differences between the images. The differences between the images can be described by a reconstruction error 450. In embodiments, the resulting image 414 can be processed through an auxiliary discriminator 430. The auxiliary discriminator can process the input image, the reconstructed image, and the target image to determine a quality, a veracity, or other parameters associated with the images. In embodiments, the auxiliary discriminator can predict a realness score for the resulting image. The realness score can be used to gauge how “real” the synthetic image appears and how useful the synthetic image will be for training a neural network. The auxiliary discriminator can provide a perceptual quality loss function 432 for the resulting image.

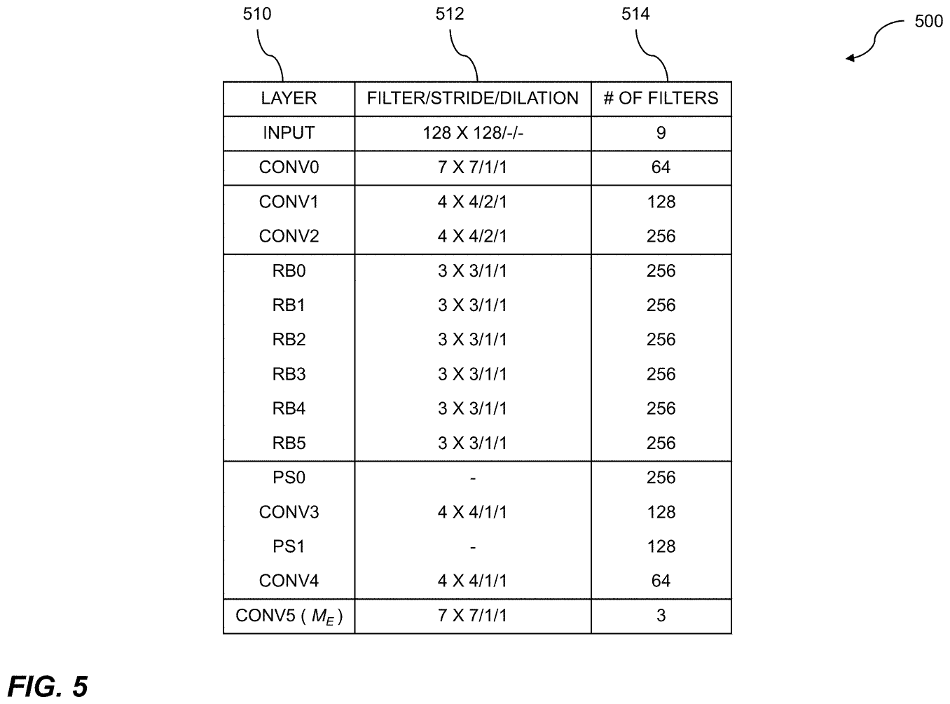

FIG. 5 is a table showing an hourglass architecture for expression mask synthesis. Discussed throughout, masks such as transformation masks can be based on an image attribute subspace. One or more transition masks can be used to synthesize a new image from an existing image. The synthesized image can differ from the original image with respect to facial image size, shape, rotation, translation, illumination, and so on. The image attributed subspace can include one or more of a plurality of subspaces within the image. In embodiments, the image attribute subspace comprises facial image expression. A transition mask, such as the transition mask associated with image facial express, can be used while processing an image to change or adjust the facial expression within the image. The changing the facial expression can include changing the facial expression within the image to a different facial expression within the synthesized image. In a usage example, the facial expression in the original image can include a frown, a smile, a smirk, a neutral expression, an angry expression, a confused expression, and so on. The facial expression in the synthesized image can include any of these facial expressions or other facial expressions. Facial image expression mask synthesis is based on a neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing.

An hourglass architecture for expression mask synthesis is shown 500. The architecture for synthesis includes a plurality of layers 510 comprising a variety of layer types. The layers within the hourglass network can include an input layer, one or more convolutional layers, one or more residual block (RB) layers, one or more pixel shuffling (PS) layers, and so on. In embodiments, the hourglass networks include convolutional layers, residual block layers, pixel shuffling layers, and activation layers. The activation layers can include rectifier linear units (ReLUs), leaky ReLUs, and so on. The hourglass architecture can further include synthesis network parameters 512, where the synthesis network parameters can include a filter size, a stride, and a dilation. The values associated with the parameters can remain consistent across all layers of the neural network or can vary for the different layers within the neural network. The hourglass architecture can further include a number of filters 514. The number of filters can remain consistent across layers of the neural network or can vary layer by layer.

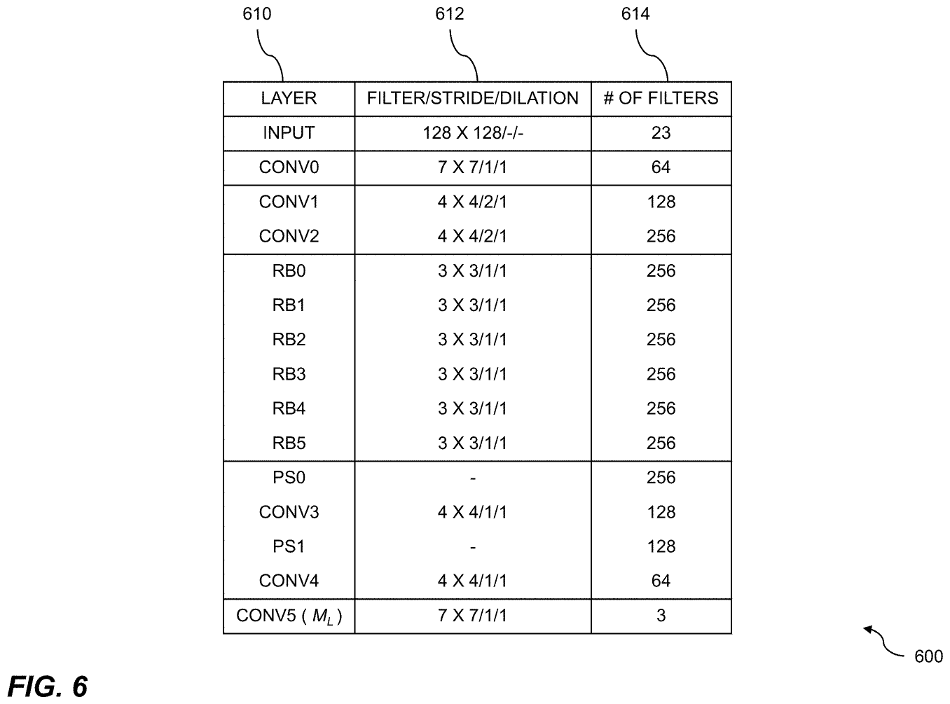

FIG. 6 is a table illustrating an hourglass architecture for lighting mask synthesis. A mask such as a transition mask can include a mask based on an image attribute subspace. The image attribute subspace can include one or more of a plurality of subspaces within the image. In embodiments, the image attribute subspace comprises facial image lighting. A transition mask, such as the transition mask associated with image lighting, can be used while processing an image to change or adjust the lighting level and lighting direction within the image. Lighting mask synthesis is based on a neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing.

An hourglass architecture for lighting mask synthesis is shown 600. The architecture for synthesis includes a plurality of layers 610, where the layers can include an input layer, one or more convolutional layers, one or more residual block (RB) layers, one or more pixel shuffling (PS) layers, and so on. The hourglass architecture can further include synthesis network parameters 612, where the synthesis network parameters can include a filter size, a stride, and a dilation. The values associated with the parameters can remain consistent across all layers of the neural network or can vary based on the layers within the neural network. The hourglass architecture can further include a number of filters 614. The number of filters can remain consistent across layers of the neural network or can vary layer by layer.

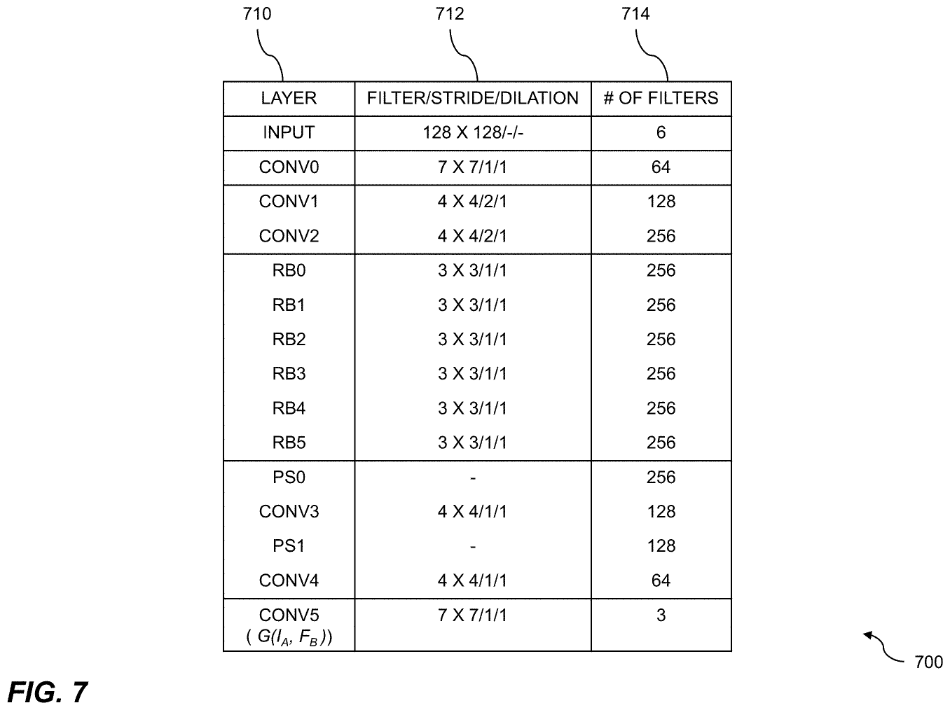

FIG. 7 is a table showing an hourglass architecture for target image synthesis. Discussed throughout, synthesis or generation of a synthetic image is accomplished using encoder-decoder pairs with output image transformation masks. These image transformation masks can be used to transform an image that includes facial image lighting and a facial image expression to a synthetic image that includes target facial lighting, lighting direction, and facial expression. Encoder-decoder pairs or hourglass networks enable a neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing. The concatenated transformation masks are processed through a third encoder-decoder pair, and a resulting image is output.

An hourglass network architecture for target image synthesis 700 includes various layers 710. In embodiments, the hourglass networks can include convolutional layers, residual block (RB) layers, pixel shuffling (PS) layers, and activation layers. Associated with each of the convolutional and pixel shuffling layers in the hourglass network is an activation layer. In embodiments, the activation layer can include a rectifier linear unit (ReLU) and instance normalization. The hourglass architecture further includes parameters such as filter, stride, and dilation 712. Substantially similar filter, stride, and dilation parameters can be associated with layers within the hourglass network, or the filter, stride, and dilation parameters can differ between layers. The hourglass architecture further includes filters 714 associated with each layer. The number of filters associated with the layers can vary across the layers of the hourglass network.

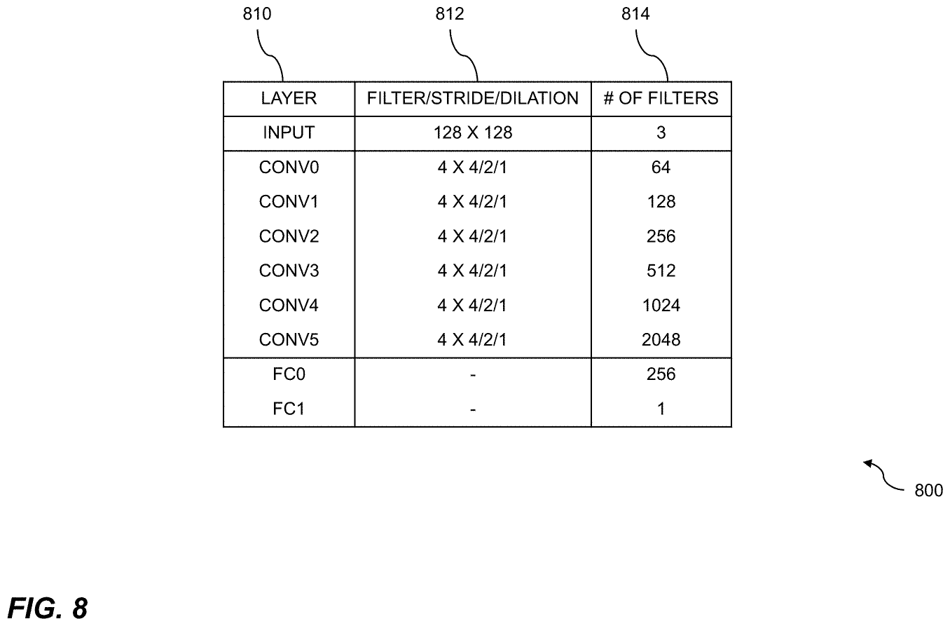

FIG. 8 is a table illustrating an architecture for a quality estimation model. A synthetic image that contains desired facial lighting, facial expression, and so on, can be generated for an unpaired image. An unpaired image is an image for which no additional or “paired” image, associated with the unpaired image, contains the desired facial lighting, facial expression, etc. Instead, a synthetic image is generated to create the desired facial lighting and facial image from the unpaired image. The quality of the synthetic image can be assessed based on a quality estimation model. The quality estimation model enables a neural network synthesis architecture using encoder-decoder models. The architecture for the quality estimation model 800 is shown. The estimation model includes layers 810, where the layers include input layers, fully connected layers, convolutional layers, activation layers, and so on. In embodiments, each of the convolutional layers is followed by an activation layer, where the activation layer can include a leaky ReLU layer. In the example architecture, the quality estimation model includes an input layer, six convolutional layers, and two fully connected layers, although in other embodiments, other numbers of input, convolutional, and fully connected layers can be included. Parameters including filter, stride, and dilation 812 parameters can be associated with each of the input and convolutional layers. These parameters do not apply to a fully connected layer because in a fully connected layer, all outputs of a previous layer are s connected to each input of the fully connected layer. The architecture for the quality estimation model can further include a number of filters 814. The number of filters associated with a layer can vary based on the layer. The quality estimation model can be used to determine the “quality” of a synthetic image. In embodiments, the quality of a synthetic image can be based “realness” of the synthetic image. The realness of the synthetic image can be represented within a realness matrix. In other embodiments, the quality of the synthetic image can be based on classification of the image. The classification can be used to determine a level of facial lighting, a facial expression, and so on. The classification can be represented by a classification map.

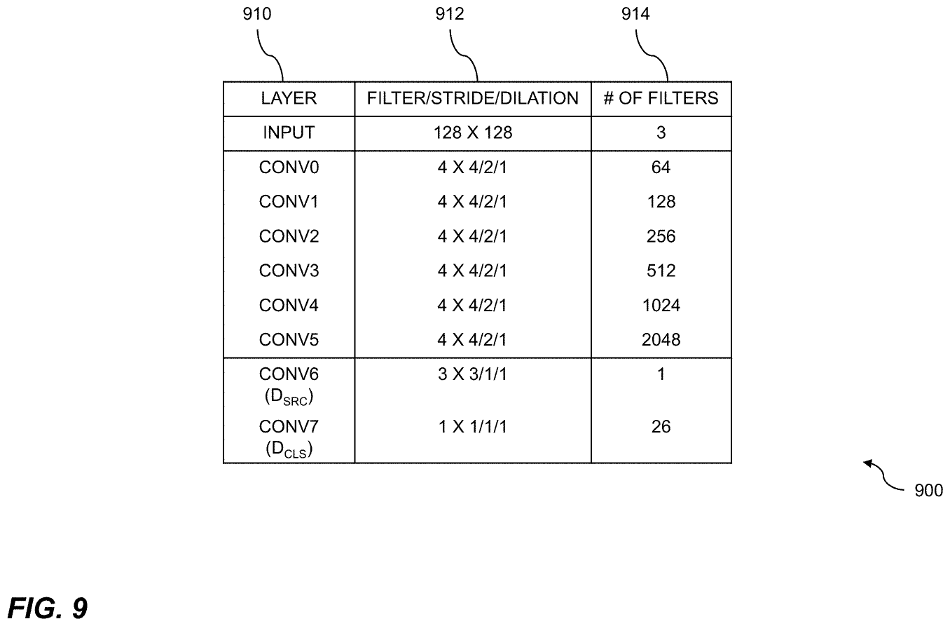

FIG. 9 is a table showing an architecture of a discriminator. The discriminator can be based on a discriminative network, where the discriminative network can be implemented within a network such as a neural network. The discriminative network can be associated with a generative network, where the discriminative network and the generative network can comprise components of a generative adversarial network or GAN. The discriminator accomplishes discriminating of an image such as a synthetic image. The discriminating of the synthetic image enables neural network synthesis architecture using encoder-decoder models. In embodiments, the resulting or synthetic image is discriminated against a known-real image. Recall that the synthetic image represents adjustments made to an image, where the adjustments can include changing facial lighting within the image, lighting source direction, facial expression within the image, and so on. The image from which the synthetic image can be generated can be an unpaired image. That is, there is no additional image associated with the original image that contains the target lighting, lighting direction, facial expression, and so on. In embodiments, discriminating can be accomplished using strided convolutional layers and activation layers within the neural network that performs the discriminating. The discriminating attempts to detect whether a given image is a real image or a synthetic image. In embodiments, the discriminating can provide a realness matrix. The realness matrix can be based on a likelihood, a probability, a metric, and so on. In other embodiments, the discriminating can provide a classification map. The classification map can be used to make determinations about the image such as the location of a face within the image. In embodiments, the classification map can predict the lighting and expression states of the resulting image.

The table 900 shows an architecture of a discriminator. The discriminator can comprise a number of layers 910 such as input layers, convolutional layers, activation layers, etc., within a neural network. The layers can include a convolutional layer followed by an activation layer. In embodiments, the activation layer can include a leaky rectifier linear unit (ReLU). For the example architecture of 900, eight convolutional layers are included. In other embodiments, other numbers of convolutional layers can be included. The architecture of the discriminator can include parameters 912 such as filter, stride, and dilation parameters associated with each convolutional layer. The filter, stride, and dilation parameters can be consistent across all convolutional layers or can vary from convolutional layer to convolutional layer. Recall that the discriminator can include a discriminator associated with a generator within an hourglass network. In embodiments, each hourglass network can downsample an image using a strided convolutional layer. The discriminator architecture and further include a number of filters 914. A number of filters can be associated with each layer within the neural network used to accomplish the discriminator. The number of filters can vary based on a particular convolutional layer.

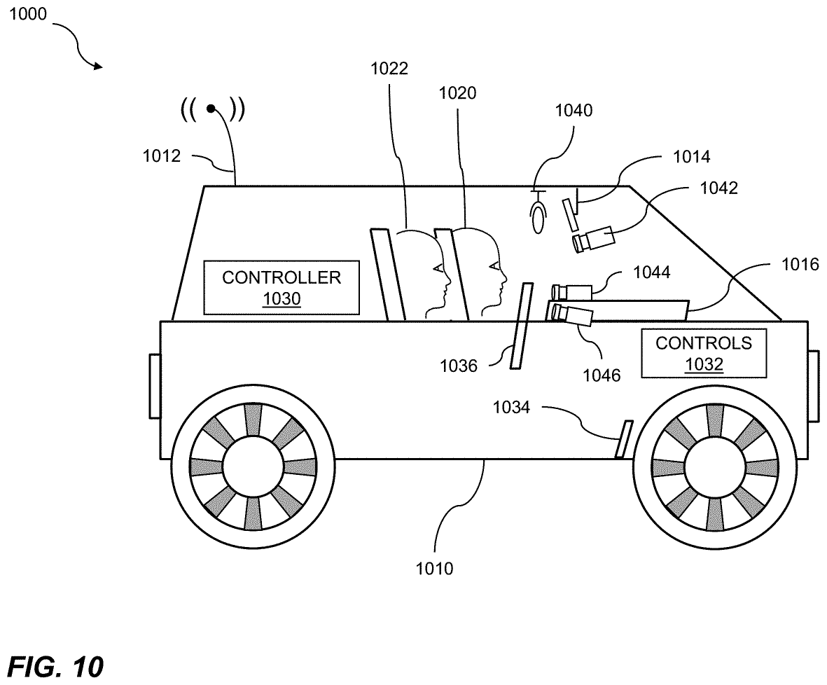

FIG. 10 is a system diagram for an interior of a vehicle 1000. Vehicle manipulation can be accomplished based on training a machine learning system. The machine learning system can include a neural network, where the neural network can be trained using one or more training datasets. The datasets can be obtained for a person in a vehicle. The collected datasets can include video data, facial data such as facial lighting data and facial expression data, audio data, voice data, physiological data, and so on. Collected image data and other data can be augmented with synthetic image data for neural network training as part of machine learning. Machine learning enables a neural network synthesis architecture using encoder-decoder models. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing. One or more occupants of a vehicle 1010, such as occupants 1020 and 1022, can be observed using a microphone 1040, one or more cameras 1042, 1044, or 1046, and other audio and image capture techniques. The image data can include video data. The video data and the audio data can include cognitive state data, where the cognitive state data can include facial data, voice data, physiological data, and the like. The occupant can be a driver 1020 of the vehicle 1010, a passenger 1022 within the vehicle, and so on.

The cameras or imaging devices that can be used to obtain images including facial data from the occupants of the vehicle 1010 can be positioned to capture the face of the vehicle operator, the face of a vehicle passenger, multiple views of the faces of occupants of the vehicle, and so on. The cameras can be located near a rear-view mirror 1014 such as camera 1042, positioned near or on a dashboard 1016 such as camera 1044, positioned within the dashboard such as camera 1046, and so on. The microphone 1040, or audio capture device, can be positioned within the vehicle such that voice data, speech data, non-speech vocalizations, and so on, can be easily collected with minimal background noise. In embodiments, additional cameras, imaging devices, microphones, audio capture devices, and so on, can be located throughout the vehicle. In further embodiments, each occupant of the vehicle could have multiple cameras, microphones, etc., positioned to capture video data and audio data from that occupant.

The interior of a vehicle 1010 can be a standard vehicle, an autonomous vehicle, a semi-autonomous vehicle, and so on. The vehicle can be a sedan or other automobile, a van, a sport utility vehicle (SUV), a truck, a bus, a special purpose vehicle, and the like. The interior of the vehicle 1010 can include standard controls such as a steering wheel 1036, a throttle control (not shown), a brake 1034, and so on. The interior of the vehicle can include other controls 1032 such as controls for seats, mirrors, climate controls, audio systems, etc. The controls 1032 of the vehicle 1010 can be controlled by a controller 1030. The controller 1030 can control the vehicle 1010 in various manners such as autonomously, semi-autonomously, assertively to a vehicle occupant 1020 or 1022, etc. In embodiments, the controller provides vehicle control or manipulation techniques, assistance, etc. The controller 1030 can receive instructions via an antenna 1012 or using other wireless techniques. The controller 1030 can be preprogrammed to cause the vehicle to follow a specific route. The specific route that the vehicle is programmed to follow can be based on the cognitive state of the vehicle occupant. The specific route can be chosen based on lowest stress, least traffic, most scenic view, shortest route, and so on.

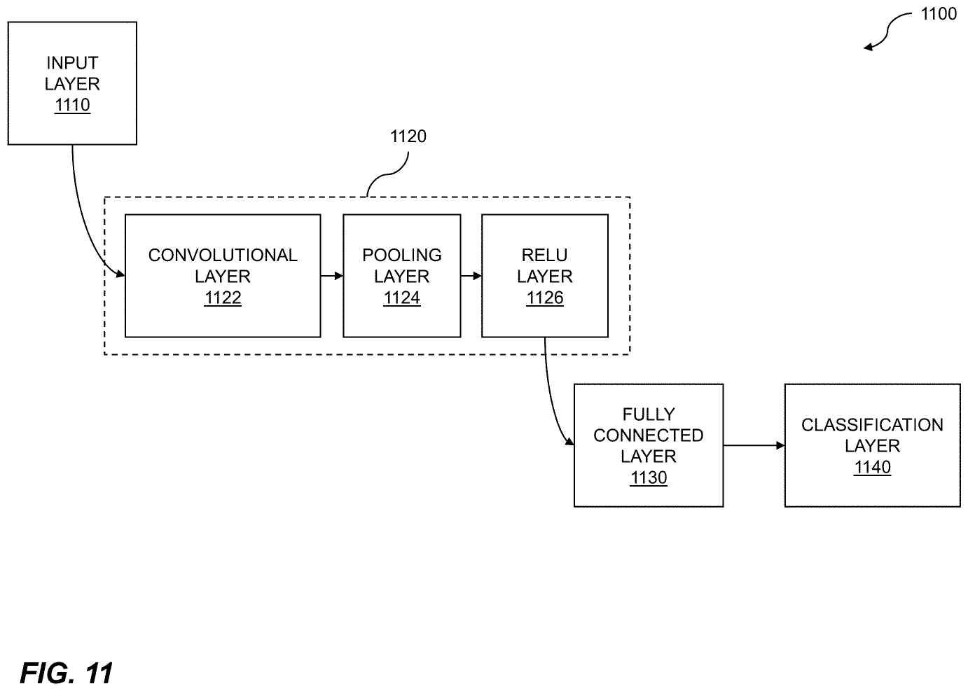

FIG. 11 is an example showing a convolutional neural network (CNN). A convolutional neural network, such as network 1100, can be used for various applications. The applications for which the CNN can be used can include deep learning, where the deep learning can be applied to a variety of analysis tasks such as facial image analysis based on unpaired facial image attributes. The convolutional neural network can be trained by applying a training dataset, such as a facial image training dataset, to the CNN. The training dataset can be augmented with synthetic data including synthetic images. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing. The concatenated masks are processed on a third encoder-decoder pair and a resulting image is output. The resulting image or synthetic image can be discriminated against a known-real image to provide a realness matrix and a classification map. The CNN can be applied to various tasks such as autonomous vehicle or semiautonomous vehicle manipulation, vehicle content recommendation, and the like. When the imaging and other data collected includes cognitive state data, the cognitive state data can include mental processes, where the mental processes can include attention, creativity, memory, perception, problem solving, thinking, use of language, or the like.

Analysis, including cognitive analysis, facial expression analysis, and so on, is a very complex task. Understanding and evaluating moods, emotions, mental states, or cognitive states, requires a nuanced evaluation of facial expressions or other cues generated by people. Cognitive state analysis is important in many areas such as research, psychology, business, intelligence, law enforcement, and so on. The understanding of cognitive states can be useful for a variety of business purposes, such as improving marketing analysis, assessing the effectiveness of customer service interactions and retail experiences, and evaluating the consumption of content such as movies and videos. Identifying points of frustration in a customer transaction can allow a company to address the causes of the frustration. By streamlining processes, key performance areas such as customer satisfaction and customer transaction throughput can be improved, resulting in increased sales and revenues. In a content scenario, producing compelling content that achieves the desired effect (e.g., fear, shock, laughter, etc.) can result in increased ticket sales and/or increased advertising revenue. If a movie studio is producing a horror movie, it is desirable to know if the scary scenes in the movie are achieving the desired effect. By conducting tests in sample audiences, and analyzing faces in the audience, a computer-implemented method and system can process thousands of faces to assess the cognitive state at the time of the scary scenes. In many ways, such an analysis can be more effective than surveys that ask audience members questions, since audience members may consciously or subconsciously change answers based on peer pressure or other factors. However, spontaneous facial expressions can be more difficult to conceal. Thus, by analyzing facial expressions en masse in real time, important information regarding the general cognitive state of the audience can be obtained.

Analysis of facial expressions is also a complex task. Image data, where the image data can include facial data, can be analyzed to identify a range of facial expressions. The facial expressions can include a smile, frown, smirk, and so on. The image data and facial data can be processed to identify the facial expressions. The processing can include analysis of expression data, action units, gestures, mental states, cognitive states, physiological data, and so on. Facial data as contained in the raw video data can include information on one or more of action units, head gestures, smiles, brow furrows, squints, lowered eyebrows, raised eyebrows, attention, and the like. The action units can be used to identify smiles, frowns, and other facial indicators of expressions. Gestures can also be identified, and can include a head tilt to the side, a forward lean, a smile, a frown, as well as many other gestures. Other types of data including physiological data can be collected, where the physiological data can be obtained using a camera or other image capture device, without contacting the person or persons. Respiration, heart rate, heart rate variability, perspiration, temperature, and other physiological indicators of cognitive state can be determined by analyzing the images and video data.

Deep learning is a branch of machine learning which seeks to imitate in software the activity which takes place in layers of neurons in the neocortex of the human brain. This imitative activity can enable software to “learn” to recognize and identify patterns in data, where the data can include digital forms of images, sounds, and so on. The deep learning software is used to simulate the large array of neurons of the neocortex. This simulated neocortex, or artificial neural network, can be implemented using mathematical formulas that are evaluated on processors. With the ever-increasing capabilities of the processors, increasing numbers of layers of the artificial neural network can be processed.

Deep learning applications include processing of image data, audio data, and so on. Image data applications include image recognition, facial recognition, etc. Image data applications can include differentiating dogs from cats, identifying different human faces, and the like. The image data applications can include identifying cognitive states, moods, mental states, emotional states, and so on, from the facial expressions of the faces that are identified. Audio data applications can include analyzing audio such as ambient room sounds, physiological sounds such as breathing or coughing, noises made by an individual such as tapping and drumming, voices, and so on. The voice data applications can include analyzing a voice for timbre, prosody, vocal register, vocal resonance, pitch, loudness, speech rate, or language content. The voice data analysis can be used to determine one or more cognitive states, moods, mental states, emotional states, etc.

The artificial neural network, such as a convolutional neural network which forms the basis for deep learning, is based on layers. The layers can include an input layer, a convolutional layer, a fully connected layer, a classification layer, and so on. The input layer can receive input data such as image data, where the image data can include a variety of formats including pixel formats. The input layer can then perform processing tasks such as identifying boundaries of the face, identifying landmarks of the face, extracting features of the face, and/or rotating a face within the plurality of images. The convolutional layer can represent an artificial neural network such as a convolutional neural network. A convolutional neural network can contain a plurality of hidden layers within it. A convolutional layer can reduce the amount of data feeding into a fully connected layer. The fully connected layer processes each pixel/data point from the convolutional layer. A last layer within the multiple layers can provide output indicative of cognitive state. The last layer of the convolutional neural network can be the final classification layer. The output of the final classification layer can be indicative of the cognitive states of faces within the images that are provided to the input layer.

Deep networks including deep convolutional neural networks can be used for facial expression parsing. A first layer of the deep network includes multiple nodes, where each node represents a neuron within a neural network. The first layer can receive data from an input layer. The output of the first layer can feed to a second layer, where the latter layer also includes multiple nodes. A weight can be used to adjust the output of the first layer which is being input to the second layer. Some layers in the convolutional neural network can be hidden layers. The output of the second layer can feed to a third layer. The third layer can also include multiple nodes. A weight can adjust the output of the second layer which is being input to the third layer. The third layer may be a hidden layer. Outputs of a given layer can be fed to the next layer. Weights adjust the output of one layer as it is fed to the next layer. When the final layer is reached, the output of the final layer can be a facial expression, a cognitive state, a mental state, a characteristic of a voice, and so on. The facial expression can be identified using a hidden layer from the one or more hidden layers. The weights can be provided on inputs to the multiple layers to emphasize certain facial features within the face. The convolutional neural network can be trained to identify facial expressions, voice characteristics, etc. The training can include assigning weights to inputs on one or more layers within the multilayered analysis engine. One or more of the weights can be adjusted or updated during training. The assigning weights can be accomplished during a feed-forward pass through the multilayered neural network. In a feed-forward arrangement, the information moves forward from the input nodes, through the hidden nodes, and on to the output nodes. Additionally, the weights can be updated during a backpropagation process through the multilayered analysis engine.

Returning to the figure, FIG. 11 is an example showing a convolutional neural network 1100. The convolutional neural network can be used for deep learning, where the deep learning can be applied to image analysis for human perception artificial intelligence. The deep learning system can be accomplished using a variety of networks. In embodiments, the deep learning can be performed using a convolutional neural network. Other types of networks or neural networks can also be used. In other embodiments, the deep learning can be performed using a recurrent neural network. The deep learning can accomplish upper torso identification, facial recognition, analysis tasks, etc. The network includes an input layer 1110. The input layer 1110 receives image data. The image data can be input in a variety of formats, such as JPEG, TIFF, BMP, and GIF. Compressed image formats can be decompressed into arrays of pixels, wherein each pixel can include an RGB tuple. The input layer 1110 can then perform processing such as identifying boundaries of the face, identifying landmarks of the face, extracting features of the face, and/or rotating a face within the plurality of images.

The network includes a collection of intermediate layers 1120. The multilayered analysis engine can include a convolutional neural network. Thus, the intermediate layers can include a convolutional layer 1122. The convolutional layer 1122 can include multiple sublayers, including hidden layers, within it. The output of the convolutional layer 1122 feeds into a pooling layer 1124. The pooling layer 1124 performs a data reduction, which makes the overall computation more efficient. Thus, the pooling layer reduces the spatial size of the image representation to reduce the number of parameters and computation in the network. In some embodiments, the pooling layer is implemented using filters of size 2×2, applied with a stride of two samples for every depth slice along both width and height, resulting in a reduction of 75-percent of the downstream node activations. The multilayered analysis engine can further include a max pooling layer 1124. Thus, in embodiments, the pooling layer is a max pooling layer, in which the output of the filters is based on a maximum of the inputs. For example, with a 2×2 filter, the output is based on a maximum value from the four input values. In other embodiments, the pooling layer is an average pooling layer or L2-norm pooling layer. Various other pooling schemes are possible.

The intermediate layers can include a Rectified Linear Units (RELU) layer 1126. The output of the pooling layer 1124 can be input to the RELU layer 1126. In embodiments, the RELU layer implements an activation function such as f(x)−max (0,x), thus providing an activation with a threshold at zero. In some embodiments, the RELU layer 1126 is a leaky RELU layer. In this case, instead of the activation function providing zero when x<0, a small negative slope is used, resulting in an activation function such as f(x)=1(x<0)(αx)+1(x>=0)(x). This can reduce the risk of “dying RELU” syndrome, where portions of the network can be “dead” with nodes/neurons that do not activate across the training dataset. The image analysis can comprise training a multilayered analysis engine using the plurality of images, wherein the multilayered analysis engine can include multiple layers that comprise one or more convolutional layers 1122 and one or more hidden layers, and wherein the multilayered analysis engine can be used for emotional analysis.

The example 1100 includes a fully connected layer 1130. The fully connected layer 1130 processes each pixel/data point from the output of the collection of intermediate layers 1120. The fully connected layer 1130 takes all neurons in the previous layer and connects them to every single neuron it has. The output of the fully connected layer 1130 provides input to a classification layer 1140. The output of the classification layer 1140 provides a facial expression and/or cognitive state as its output. Thus, a multilayered analysis engine such as the one depicted in FIG. 11 processes image data using weights, models the way the human visual cortex performs object recognition and learning, and effectively analyzes image data to infer facial expressions and cognitive states.

Machine learning for generating parameters, analyzing data such as facial data and audio data, and so on, can be based on a variety of computational techniques. Generally, machine learning can be used for constructing algorithms and models. The constructed algorithms, when executed, can be used to make a range of predictions relating to data. The predictions can include whether an object in an image is a face, a box, or a puppy; whether a voice is female, male, or robotic; whether a message is legitimate email or a “spam” message; and so on. The data can include unstructured data and can be of large quantity. The algorithms that can be generated by machine learning techniques are particularly useful to data analysis because the instructions that comprise the data analysis technique do not need to be static. Instead, the machine learning algorithm or model, generated by the machine learning technique, can adapt. Adaptation of the learning algorithm can be based on a range of criteria such as success rate, failure rate, and so on. A successful algorithm is one that can adapt—or learn—as more data is presented to the algorithm. Initially, an algorithm can be “trained” by presenting it with a set of known data (supervised learning). Another approach, called unsupervised learning, can be used to identify trends and patterns within data. Unsupervised learning is not trained using known data prior to data analysis.

Reinforced learning is an approach to machine learning that is inspired by behaviorist psychology. The underlying premise of reinforced learning (also called reinforcement learning) is that software agents can take actions in an environment. The actions that are taken by the agents should maximize a goal such as a “cumulative reward”. A software agent is a computer program that acts on behalf of a user or other program. The software agent is implied to have the authority to act on behalf of the user or program. The actions taken are decided by action selection to determine what to do next. In machine learning, the environment in which the agents act can be formulated as a Markov decision process (MDP). The MDPs provide a mathematical framework for modeling of decision making in environments where the outcomes can be partly random (stochastic) and partly under the control of the decision maker. Dynamic programming techniques can be used for reinforced learning algorithms. Reinforced learning is different from supervised learning in that correct input/output pairs are not presented, and suboptimal actions are not explicitly corrected. Rather, online or computational performance is the focus. Online performance includes finding a balance between exploration of new (uncharted) territory or spaces and exploitation of current knowledge. That is, there is a tradeoff between exploration and exploitation.

Machine learning based on reinforced learning adjusts or learns based on learning an action, a combination of actions, and so on. An outcome results from taking an action. Thus, the learning model, algorithm, etc., learns from the outcomes that result from taking the action or combination of actions. The reinforced learning can include identifying positive outcomes, where the positive outcomes are used to adjust the learning models, algorithms, and so on. A positive outcome can be dependent on a context. When the outcome is based on a mood, emotional state, mental state, cognitive state, etc., of an individual, then a positive mood, emotion, mental state, or cognitive state can be used to adjust the model and the algorithm. Positive outcomes can include the person being more engaged, where engagement is based on affect, the person spending more time playing an online game or navigating a webpage, the person converting by buying a product or service, and so on. The reinforced learning can be based on exploring a solution space and adapting the model, algorithm, etc., which stem from outcomes of the exploration. When positive outcomes are encountered, the positive outcomes can be reinforced by changing weighting values within the model, algorithm, etc. Positive outcomes may result in increased weighting values. Negative outcomes can also be considered, where weighting values may be reduced or otherwise adjusted.

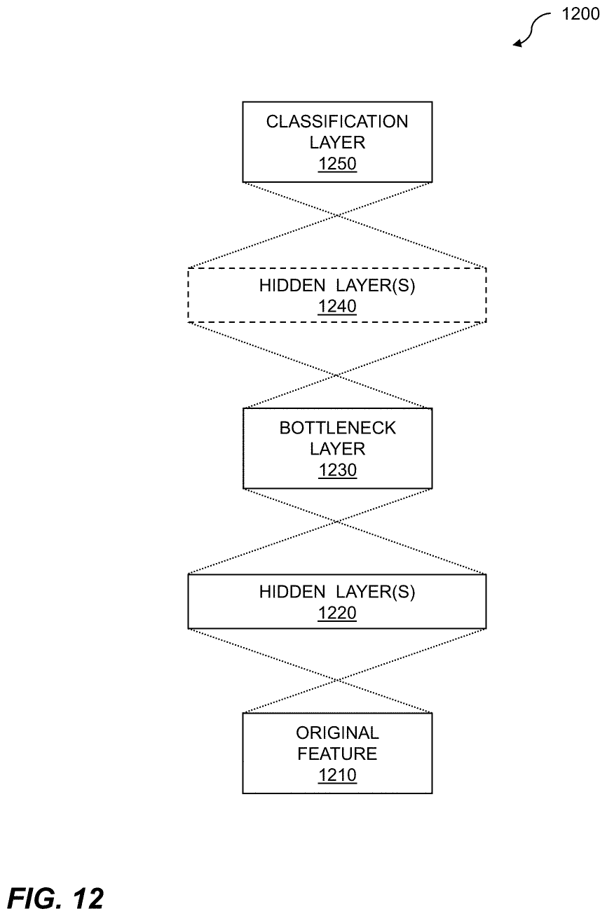

FIG. 12 illustrates a bottleneck layer within a deep learning environment. The deep learning environment can include a machine learning system, where the machine learning system can be based on a neural network such as a deep neural network. The deep neural network comprises a plurality of layers such as input layers, output layers, convolutional layers, residual block layers, pixel shuffling layers, activation layers, and so on. The plurality of layers in a deep neural network (DNN) can include a bottleneck layer. The bottleneck layer can be used for neural network training, where the training can be applied to a neural network synthesis architecture using encoder-decoder models. The neural network that is trained can be applied to analysis such as image analysis of facial images for facial elements, audio analysis, physiological analysis, etc. A deep neural network can apply classifiers such as object classifiers, image classifiers, facial classifiers, facial expression classifiers, audio classifiers, speech classifiers, physiological classifiers, and so on. The classifiers can be learned by analyzing one or more of facial elements, cognitive states, cognitive load metrics, interaction metrics, etc. A facial image is obtained for processing on a neural network, wherein the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing.

Layers of a deep neural network can include a bottleneck layer 1200. A bottleneck layer can be used for a variety of applications such as identification of a facial portion, identification of an upper torso, facial recognition, voice recognition, emotional state recognition, and so on. The deep neural network in which the bottleneck layer is located can include a plurality of layers. The plurality of layers can include an original feature layer 1210. A feature such as an image feature can include points, edges, objects, boundaries between and among regions, properties, and so on. The deep neural network can include one or more hidden layers 1220. The one or more hidden layers can include nodes, where the nodes can include nonlinear activation functions and other techniques. The bottleneck layer can be a layer that learns translation vectors to transform a neutral face to an emotional or expressive face. In some embodiments, the translation vectors can transform a neutral sounding voice to an emotional or expressive voice. Specifically, activations of the bottleneck layer determine how the transformation occurs. A single bottleneck layer can be trained to transform a neutral face or voice to a different emotional face or voice. In some cases, an individual bottleneck layer can be trained for a transformation pair. At runtime, once the user's emotion has been identified and an appropriate response to it can be determined (mirrored or complementary), the trained bottleneck layer can be used to perform the needed transformation.

The deep neural network can include a bottleneck layer 1230. The bottleneck layer can include a fewer number of nodes than the one or more preceding hidden layers. The bottleneck layer can create a constriction in the deep neural network or other network. The bottleneck layer can force information that is pertinent to a classification, for example, into a low dimensional representation. The bottleneck features can be extracted using an unsupervised technique. In other embodiments, the bottleneck features can be extracted using a supervised technique. The supervised technique can include training the deep neural network with a known dataset. The features can be extracted from an autoencoder such as a variational autoencoder, a generative autoencoder, and so on. The deep neural network can include hidden layers 1240. The number of the hidden layers can include zero hidden layers, one hidden layer, a plurality of hidden layers, and so on. The hidden layers following the bottleneck layer can include more nodes than the bottleneck layer. The deep neural network can include a classification layer 1250. The classification layer can be used to identify the points, edges, objects, boundaries, and so on, described above. The classification layer can be used to identify cognitive states, mental states, emotional states, moods, and the like. The output of the final classification layer can be indicative of the emotional states of faces within the images, where the images can be processed using the deep neural network.

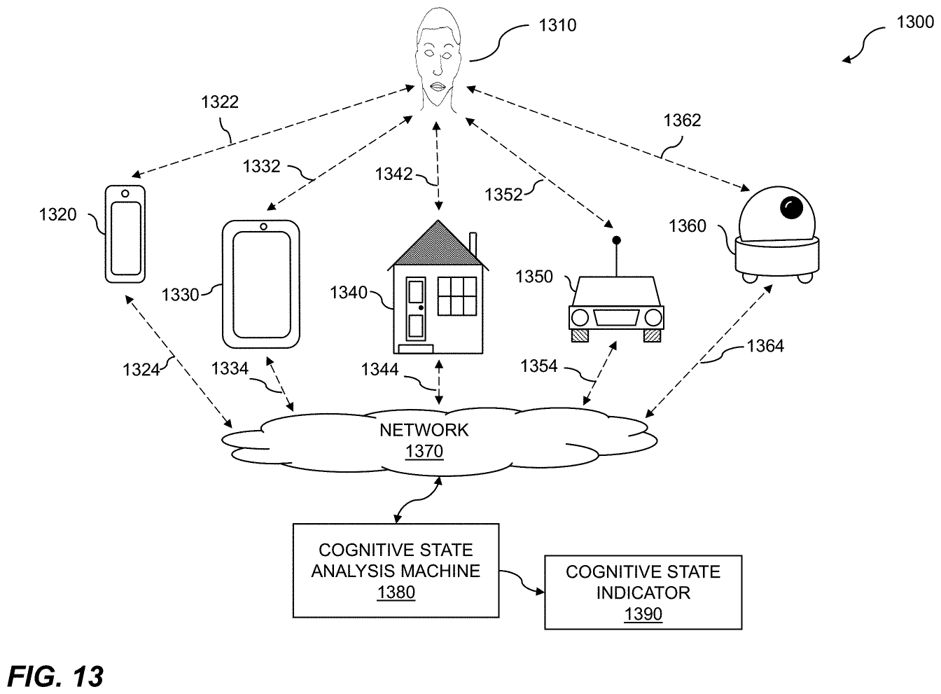

FIG. 13 shows data collection including devices and locations 1300. Data, including imaging data, facial image data, torso data, video data, audio data, and physiological data can be obtained for machine learning. The machine learning can be applied neural network synthesis architecture using encoder-decoder models. The training, imaging, audio, physiological, and other data can be obtained from multiple devices, vehicles, and locations. A facial image is obtained for processing on a neural network, where the facial image includes unpaired facial image attributes. The facial image is processed through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace. The first image transformation mask and the second image transformation mask are concatenated to enable downstream processing. The first image transformation mask and the second image transformation mask that are concatenated are processed on a third encoder-decoder pair. A resulting image is output from the third encoder-decoder pair.

The multiple mobile devices, vehicles, and locations 1300 can be used separately or in combination to collect imaging, video data, audio data, physio data, training data, etc., on a user 1310. The imaging can include video data, where the video data can include upper torso data. Other data such as audio data, physiological data, and so on, can be collected on the user. While one person is shown, the video data, or other data, can be collected on multiple people. A user 1310 can be observed as she or he is performing a task, experiencing an event, viewing a media presentation, and so on. The user 1310 can be shown one or more media presentations, political presentations, social media, or another form of displayed media. The one or more media presentations can be shown to a plurality of people. The media presentations can be displayed on an electronic display coupled to a client device. The data collected on the user 1310 or on a plurality of users can be in the form of one or more videos, video frames, still images, etc. The plurality of videos can be of people who are experiencing different situations. Some example situations can include the user or plurality of users being exposed to TV programs, movies, video clips, social media, social sharing, and other such media. The situations could also include exposure to media such as advertisements, political messages, news programs, and so on. As previously noted, video data can be collected on one or more users in substantially identical or different situations and viewing either a single media presentation or a plurality of presentations. The data collected on the user 1310 can be analyzed and viewed for a variety of purposes including body position or body language analysis, expression analysis, mental state analysis, cognitive state analysis, and so on. The electronic display can be on a smartphone 1320 as shown, a tablet computer 1330, a personal digital assistant, a television, a mobile monitor, or any other type of electronic device. In one embodiment, expression data is collected on a mobile device such as a cell phone 1320, a tablet computer 1330, a laptop computer, or a watch. Thus, the multiple sources can include at least one mobile device, such as a phone 1320 or a tablet 1330, or a wearable device such as a watch or glasses (not shown). A mobile device can include a front-side camera and/or a back-side camera that can be used to collect expression data. Sources of expression data can include a webcam, a phone camera, a tablet camera, a wearable camera, and a mobile camera. A wearable camera can comprise various camera devices, such as a watch camera. In addition to using client devices for data collection from the user 1310, data can be collected in a house 1340 using a web camera or the like; in a vehicle 1350 using a web camera, client device, etc.; by a social robot 1360; and so on.

As the user 1310 is monitored, the user 1310 might move due to the nature of the task, boredom, discomfort, distractions, or for another reason. As the user moves, the camera with a view of the user's face can be changed. Thus, as an example, if the user 1310 is looking in a first direction, the line of sight 1322 from the smartphone 1320 is able to observe the user's face, but if the user is looking in a second direction, the line of sight 1332 from the tablet 1330 is able to observe the user's face. Furthermore, in other embodiments, if the user is looking in a third direction, the line of sight 1342 from a camera in the house 1340 is able to observe the user's face, and if the user is looking in a fourth direction, the line of sight 1352 from the camera in the vehicle 1350 is able to observe the user's face. If the user is looking in a fifth direction, the line of sight 1362 from the social robot 1360 is able to observe the user's face. If the user is looking in a sixth direction, a line of sight from a wearable watch-type device, with a camera included on the device, is able to observe the user's face. In other embodiments, the wearable device is another device, such as an earpiece with a camera, a helmet or hat with a camera, a clip-on camera attached to clothing, or any other type of wearable device with a camera or other sensor for collecting expression data. The user 1310 can also use a wearable device including a camera for gathering contextual information and/or collecting expression data on other users. Because the user 1310 can move her or his head, the facial data can be collected intermittently when she or he is looking in a direction of a camera. In some cases, multiple people can be included in the view from one or more cameras, and some embodiments include filtering out faces of one or more other people to determine whether the user 1310 is looking toward a camera. All or some of the expression data can be continuously or sporadically available from the various devices and other devices.

The captured video data can include cognitive content, such as facial expressions, etc., and can be transferred over a network 1370. The network can include the Internet or other computer network. The smartphone 1320 can share video using a link 1324, the tablet 1330 using a link 1334, the house 1340 using a link 1344, the vehicle 1350 using a link 1354, and the social robot 1360 using a link 1364. The links 1324, 1334, 1344, 1354, and 1364 can be wired, wireless, and hybrid links. The captured video data, including facial expressions, can be analyzed on a cognitive state analysis machine 1380, on a computing device such as the video capture device, or on another separate device. The analysis could take place on one of the mobile devices discussed above, on a local server, on a remote server, and so on. In embodiments, some of the analysis takes place on the mobile device, while other analysis takes place on a server device. The analysis of the video data can include the use of a classifier. The video data can be captured using one of the mobile devices discussed above and sent to a server or another computing device for analysis. However, the captured video data including expressions can also be analyzed on the device which performed the capturing. The analysis can be performed on a mobile device where the videos were obtained with the mobile device and wherein the mobile device includes one or more of a laptop computer, a tablet, a PDA, a smartphone, a wearable device, and so on. In another embodiment, the analyzing comprises using a classifier on a server or another computing device different from the capture device. The analysis data from the cognitive state analysis engine can be processed by a cognitive state indicator 1390. The cognitive state indicator 1390 can indicate cognitive states, mental states, moods, emotions, etc. In embodiments, the cognitive state can include drowsiness, fatigue, distraction, impairment, sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, depression, envy, sympathy, embarrassment, poignancy, or mirth.

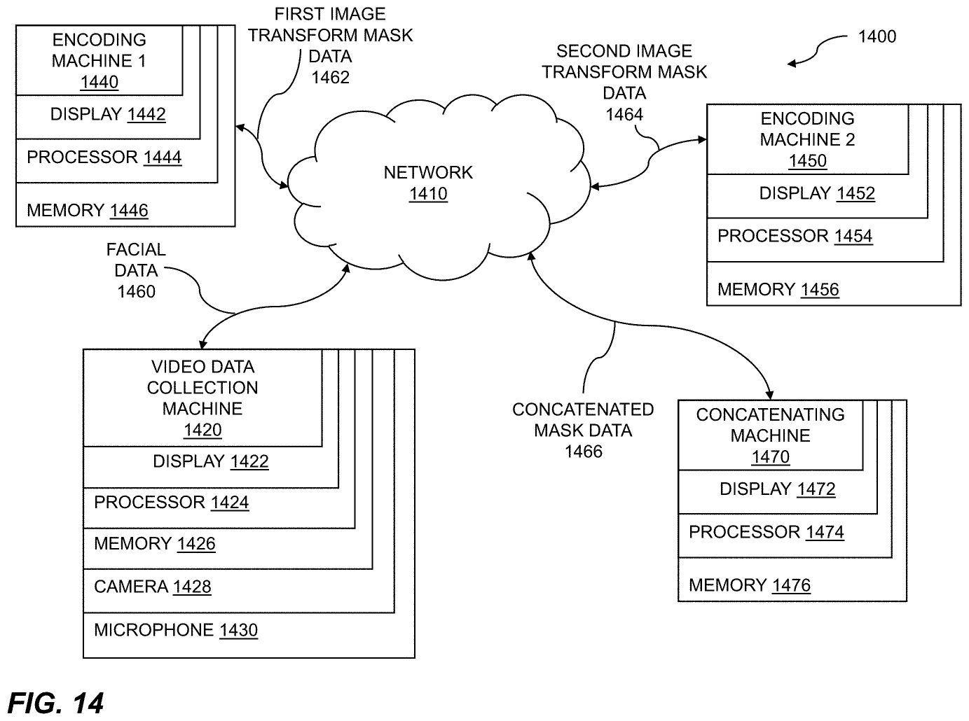

FIG. 14 is a system for a neural network synthesis architecture using encoder-decoder models. Machine learning can be accomplished using one or more computers or processors on which a neural network can be executed. An example system 1400 which can perform machine learning is shown. The neural network for machine learning can include a machine learning neural network, a deep learning neural network, a convolutional neural network, a recurrent neural network, and so on. The system 1400 can include a memory which stores instructions and one or more processors coupled to the memory, wherein the one or more processors, when executing the instructions which are stored, are configured to: obtain a facial image for processing on a neural network, wherein the facial image includes unpaired facial image attributes; process the facial image through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace; and concatenate the first image transformation mask and the second image transformation mask to enable downstream processing.

Embodiments include comprising processing the first image transformation mask and the second image transformation mask that are concatenated on a third encoder-decoder pair. The third encoder-decoder pair can include processors within the neural network or within a separate neural network. Further embodiments include outputting a resulting image from the third encoder-decoder pair. The resulting image can include a synthetic image that can represent desired facial image features such facial image lighting, direction of light source, facial image expression, and so on. Embodiments include discriminating the resulting image against a known-real image. The discriminating can be used to determine a quality of the image. In embodiments, the discriminating provides a realness matrix. The realness matrix can include values, weights, percentages, and so on regarding a likelihood that the image contains a real face or a synthetic face. In further embodiments, the discriminating provides a classification map. The classification map can show regions of the image which are likely to be real, likely to be unreal, and the like. In further embodiments, the system 1400 can provide a computer-implemented method for machine learning comprising: obtaining a facial image for processing on a neural network, wherein the facial image includes unpaired facial image attributes; processing the facial image through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace; and concatenating the first image transformation mask and the second image transformation mask to enable downstream processing.

The system 1400 can include one or more video data collection machines 1420 linked to a first encoding machine 1440, a second encoding machine 1450, and a concatenating machine 1470 via a network 1410 or another computer network. The network can be wired or wireless, a computer network such as the Internet, a local area network (LAN), a wide area network (WAN), and so on. Facial data 1460 such as facial image data, facial element data, training data, and so on, can be transferred to the first encoding machine 1440 and to the second encoding machine 1450 through the network 1410. The example video data collection machine 1420 shown comprises one or more processors 1424 coupled to a memory 1426 which can store and retrieve instructions, a display 1422, a camera 1428, and a microphone 1430. The camera 1428 can include a webcam, a video camera, a still camera, a thermal imager, a CCD device, a phone camera, a three-dimensional camera, a depth camera, a light field camera, multiple webcams used to show different views of a person, or any other type of image capture technique that can allow captured data to be used in an electronic system. The microphone can include any audio capture device that can enable captured audio data to be used by the electronic system. The memory 1426 can be used for storing instructions, video data including facial images, facial expression data, facial lighting data, etc. on a plurality of people; audio data from the plurality of people; one or more classifiers; and so on. The display 1422 can be any electronic display, including but not limited to, a computer display, a laptop screen, a netbook screen, a tablet computer screen, a smartphone display, a mobile device display, a remote with a display, a television, a projector, or the like.

The first encoding machine 1440 can include one or more processors 1444 coupled to a memory 1446 which can store and retrieve instructions, and can also include a display 1442. The first encoding machine 1440 can receive the facial image data 1460 and can process the facial image through a first encoder-decoder pair. The facial image data can include unpaired-image training data. The first encoder-decoder pair decomposes a first image attribute subspace. The attribute subspace can describe a characteristic or feature associated with the face within the image that can be identified within the image. The first attribute subspace can include facial image lighting, a facial image expression, and so on. Facial image lighting can include a direction from which the light emanates. The first encoder-decoder pair outputs first image transformation mask data 1462 based on the first image attribute subspace. The second encoding machine 1450 can include one or more processors 1454 coupled to a memory 1456 which can store and retrieve instructions, and can also include a display 1452. The second encoding machine 1450 can receive the facial image data 1460 and can process the facial image through a second encoder-decoder pair. The second encoder-decoder pair decomposes a second image attribute subspace. As stated throughout, the attribute subspace can describe a characteristic or feature associated with the face that can be identified within the image. The second attribute subspace can include a facial image expression. In embodiments, the facial image expression can include a smile, frown, or smirk of varying intensities; eyebrow furrows; and so on. The second encoder-decoder pair outputs second image transformation mask data 1464 based on the second image attribute subspace.

The concatenating machine 1470 can include one or more processors 1474 coupled to a memory 1476 which can store and retrieve instructions and data, and can also include a display 1472. The concatenating machine can concatenate the first image transformation mask and the second image transformation mask to enable downstream processing. The concatenating the first image transformation mask and the second image transformation mask generates concatenated mask data 1466. The downstream processing can include processing on the neural network, processing through an additional encoder-decoder pair, and so on. Embodiments include processing the first image transformation mask and the second image transformation mask that are concatenated on a third encoder-decoder pair. As for the first encoder-decoder pair and the second encoder-decoder pair, processing on the third encoder-decoder pair can decompose an additional attribute space. The additional attribute space can be associated with facial image lighting, lighting direction, facial image expression, and so on. Further embodiments include outputting a resulting image from the third encoder-decoder pair. The resulting image can include a synthetic image, where the synthetic image is generated to simulate a target facial image lighting and facial image expression. In a usage example, the simulated image can include bright lighting and a happy smile, dim lighting and a menacing frown, and the like.

In embodiments, the concatenating the first image transformation mask and the second image transformation mask to enable downstream processing occurs on the video data collection machine 1420, the first encoding machine 1440, or on the second encoding machine 1450. As shown in the system 1400, the concatenating machine 1470 can receive the first image transformation mask data 1462 and the second image transformation mask data 1464 via the network 1410, the Internet, or another network; from the video data collection machine 1420; from the first encoding machine 1440; from the second encoding machine 1450; or from all. The first image transformation mask data and the second image transformation mask data can be shown as a visual rendering on a display or any other appropriate display format.

The system 1400 can include a computer program product embodied in a non-transitory computer readable medium for machine learning, the computer program product comprising code which causes one or more processors to perform operations of: obtaining a facial image for processing on a neural network, wherein the facial image includes unpaired facial image attributes; processing the facial image through a first encoder-decoder pair and a second encoder-decoder pair, wherein the first encoder-decoder pair decomposes a first image attribute subspace and the second encoder-decoder pair decomposes a second image attribute subspace, and wherein the first encoder-decoder pair outputs a first image transformation mask based on the first image attribute subspace and the second encoder-decoder pair outputs a second image transformation mask based on the second image attribute subspace; and concatenating the first image transformation mask and the second image transformation mask to enable downstream processing.

Each of the above methods may be executed on one or more processors on one or more computer systems. Each of the above methods may be implemented on a semiconductor chip and programmed using special purpose logic, programmable logic, and so on. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for machine learning comprising:
obtaining a facial image for processing on a neural network, wherein the facial image includes unpaired facial image attributes;
processing the facial image through a first encoder-decoder pair and a second encoder-decoder pair, wherein the first encoder-decoder pair decomposes a first image attribute subspace and the second encoder-decoder decomposes a second image attribute subspace, and wherein the first encoder-decoder pair outputs a first image transformation mask based on the first image attribute subspace and the second encoder-decoder pair outputs a second image transformation mask based on the second image attribute subspace; and
concatenating the first image transformation mask and the second image transformation mask to enable downstream processing.

2. The method of claim 1 further comprising processing the first image transformation mask and the second image transformation mask that are concatenated on a third encoder-decoder pair.

3. The method of claim 2 further comprising outputting a resulting image from the third encoder-decoder pair.

4. The method of claim 3 wherein the resulting image that is output eliminates a paired training data requirement for the neural network to learn two or more facial image transformations.

5. The method of claim 3 wherein the first image attribute subspace comprises facial image lighting.

6. The method of claim 5 wherein the first image transformation mask includes changing facial image lighting.

7. The method of claim 6 wherein the second image attribute subspace comprises facial image expression.

8. The method of claim 7 wherein the second image transformation mask includes changing a facial image expression.

9. The method of claim 8 wherein the resulting image is hallucinated to a new synthetic image based on changing facial image lighting and facial image expression.

10. The method of claim 8 wherein the image that is hallucinated comprises a synthetic image.

11. The method of claim 6 wherein the changing facial image lighting includes changing a direction of the lighting on the facial image.

12. The method of claim 3 wherein the third encoder-decoder pair combines feature maps from previously decomposed attribute subspaces.

13. The method of claim 3 wherein the encoder-decoder pairs comprise hourglass networks.

14. The method of claim 13 wherein the hourglass networks include convolutional layers, residual block layers, pixel shuffling layers, and activation layers.

15. The method of claim 14 wherein each hourglass network downsamples an image using a strided convolutional layer.

16. The method of claim 3 further comprising discriminating the resulting image against a known-real image.

17. The method of claim 16 wherein the discriminating is accomplished using strided convolutional layers and activation layers.

18. The method of claim 17 wherein the discriminating provides a realness matrix.

19. The method of claim 17 wherein the discriminating provides a classification map.

20. The method of claim 19 wherein the classification map predicts lighting and expression states of the resulting image.

21. The method of claim 20 further comprising comparing the prediction with a target set by a user.

22. The method of claim 3 further comprising processing the resulting image through an auxiliary discriminator.

23. The method of claim 22 wherein the auxiliary discriminator provides a perceptual quality loss function for the resulting image.

24. The method of claim 22 wherein the auxiliary discriminator predicts a realness score for the resulting image.

25. The method of claim 1 wherein the processing of the facial image enables disentanglement of the first image attribute subspace and the second image attribute subspace for the facial image.

26. The method of claim 25 wherein the disentanglement enables separate neural network processing of the facial image for the first image attribute subspace and the second image attribute subspace.

27-32. (canceled)

33. A computer program product embodied in a non-transitory computer readable medium for machine learning, the computer program product comprising code which causes one or more processors to perform operations of:
obtaining a facial image for processing on a neural network, wherein the facial image includes unpaired facial image attributes;
processing the facial image through a first encoder-decoder pair and a second encoder-decoder pair, wherein the first encoder-decoder pair decomposes a first image attribute subspace and the second encoder-decoder decomposes a second image attribute subspace, and wherein the first encoder-decoder pair outputs a first image transformation mask based on the first image attribute subspace and the second encoder-decoder pair outputs a second image transformation mask based on the second image attribute subspace; and
concatenating the first image transformation mask and the second image transformation mask to enable downstream processing.

34. A computer system for machine learning comprising:
a memory which stores instructions;
one or more processors coupled to the memory wherein the one or more processors, when executing the instructions which are stored, are configured to:
obtain a facial image for processing on a neural network, wherein the facial image includes unpaired facial image attributes;
process the facial image through a first encoder-decoder pair and a second encoder-decoder pair, wherein the first encoder-decoder pair decomposes a first image attribute subspace and the second encoder-decoder decomposes a second image attribute subspace, and wherein the first encoder-decoder pair outputs a first image transformation mask based on the first image attribute subspace and the second encoder-decoder pair outputs a second image transformation mask based on the second image attribute subspace; and
concatenate the first image transformation mask and the second image transformation mask to enable downstream processing.
